(19) United States
(12) Patent Application Publication
(10) Pub. No.: US 2007/0192818 A1
(43) Pub. Date: Aug. 16, 2007

(54) System and method for creating, distributing, and executing rich multimedia applications

(76) Inventors: Mikael Bourges-Sevenier, Cupertino, CA (US); Paul Collins, Oakland, CA (US)

Correspondence Address: HELLER EHRMAN LLP, 4350 LA JOLLA VILLAGE DRIVE #700, 7TH FLOOR, SAN DIEGO, CA, 92122, US

(21) Appl. No.: 11/250,003

(22) Filed: Oct. 12, 2005

Related U.S. Application Data
(60) Provisional application No. 60/618,455, filed on Oct. 12, 2004.
(60) Provisional application No. 60/618,365, filed on Oct. 12, 2004.
(60) Provisional application No. 60/618,333, filed on Oct. 12, 2004.
(60) Provisional application No. 60/634,183, filed on Dec. 7, 2004.

(51) Int. Cl. H04N 7/173; H04N 7/16

(52) U.S. Cl. 725/132; 725/100; 725/131; 725/139; 725/151

(57) ABSTRACT

The aim of this invention is to provide a complete system to create, to deploy and to execute rich multimedia applications on various terminals and in particular embedded devices. A rich multimedia application is made of one or more media objects, being audio or visual, synthetic or natural, metadata, and their protection being composed and rendered on a display device over time in response to preprogrammed logic and user interaction. We describe the architecture of such a terminal, how to implement it on a variety of operating systems and devices, and how it executes downloaded rich, interactive, multi-media applications, and the architecture of such applications.

### REFERENCE TO PRIORITY DOCUMENT

This application claims priority of co-pending U.S. Provisional Application Ser. No. 60/618,455 entitled “System and Method for Creating, Distributing, and Executing Rich Multimedia Applications” by Mikael Bourges-Sevenier filed Oct. 12, 2004; U.S. Provisional Application Ser. No. 60/618,365 entitled “System and Method for Low-Level Graphic Methods Access for Distributed Applications” by Mikael Bourges-Sevenier filed Oct. 12, 2004; U.S. Provisional Application Ser. No. 60/618,333 entitled “System and Method for Efficient Implementation of MPEG-Based Terminals with Low-Level Graphic Access” by Mikael Bourges-Sevenier filed Oct. 12, 2004; U.S. Provisional Application Ser. No. 60/634,183 entitled “A Multimedia Architecture for Next Generation DVDs” by Mikael Bourges-Sevenier et al. filed Dec. 7, 2004. Priority of the filing dates of these applications is hereby claimed, and the disclosures of the Provisional Applications are hereby incorporated by reference.

### COMPUTER PROGRAM LISTING APPENDIX

Two identical compact discs (CDs) are being filed with this document. The content of the CDs is hereby incorporated by reference as if fully set forth herein. Each CD contains three files of computer code used in a non-limiting embodiment of the invention. The files on each CD are listed in the File Listing Appendix at the end of the specification.

### COPYRIGHT NOTIFICATION

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

A multimedia application executing on a terminal is made of one or more media objects that are composed together in space (i.e. on the screen or display of the terminal) and time, based on the logic of the application. A media object can be:
Audio objects—a compressed or uncompressed representation of a sound that is played on terminal's speakers.
Visual objects—objects that provide a visual representation that is typically drawn or rendered onto the screen of the terminal. Such objects include still pictures and video (also called natural objects) and computer graphics objects (also called synthetic objects)
Metadata—any type of information that may describe audio-visual objects
Scripted logic—whether expressed in a special representation (e.g. a scene graph) or a computer language (e.g. native code, bytecodes, scripts)
Security information (e.g. rights management, encryption keys and so on)
   Audio-visual objects can be
Natural—their description comes from natural means via a transducer or capture device such as a microphone or a camera,
Synthetic—their description is a “virtual” specification that comes from a computer. This includes artwork made with a computer and vector graphics.

Each media object may be transported by means of a description or format that may be compressed or not, encrypted or not. Typically, such description is carried in parts in a streaming environment from a stored representation on a server's file system. Such file formats may also be available on the terminal.

In early systems, a multimedia application consisted of a video stream and one or more audio streams. Upon reception of such an application, the terminal would play the video using a multimedia player and allow the user to choose between audio streams. In such systems, the logic of the application is embedded in the player that is executed by the terminal; no logic is stored in the content of the application. Moreover, the logic of the application is deterministic: the movie (application) is always played from a start point to an end point at a certain speed.

With the need of more interactive and customizable contents, DVDs were the first successful consumer systems to propose a finite set of commands to allow the user to navigate among many audio-video contents on a DVD. Unfortunately, being finite, this set of commands doesn't provide much interactivity besides simple buttons. Over time, the DVD specification was augmented with more commands but few titles were able to use them because titles needed to be backward compatible with existing players on the market. DVD commands create a deterministic behavior: the content is played sequentially and may branch to one content or another depending on anchors (or buttons) the user can select.

On the other end, successful advanced multimedia applications, such as games, are often characterized by a non-deterministic behavior: running the application multiple times may create different output. In general, interactive applications are non-deterministic as they tend to resemble more to lively systems; life is non-deterministic.

With the advent of the Internet era, more flexible markup languages were invented typically based on XML language or other textual description programming language. The XML language provides a simple and generic syntax to describe practically anything, as long as its syntax is used to create an extensible language. However, such language has the same limitations as those with finite set of commands (e.g. like DVDs). Recently, standards such as MPEG-4/7/21 used XML to describe composition of media. Using a set of commands or descriptors or tags to represent multimedia concepts, the language grew quickly to encompass so many multi-media possibilities that it became non practical or non usable. An interesting fact often mentioned is that applications may use different commands but typically only 10% would be needed. As such, implementing terminals or devices with all commands would become a huge waste of time and resources (both in terms of hardware/software and engineering time).

Today, a new generation of web applications uses APIs available in the web browser directly or from applications available to the web browser. This enable creation of applications quickly by reusing other applications as components and, since these components have been well tested, such aggregate applications are cheaper to develop. This allows components to evolve separately without recompiling the applications as long as their API doesn't change. The invention described in this document is based on the same principle but with a framework dedicated to multimedia entertainment rather than documents (as for web applications).

On the other end, the explosion of mobile devices (in particular phones) followed a different path. Instead of supporting a textual description (e.g. XML) compressed or not, they provide a runtime environment and a set of APIs. The Java language environment is predominant on mobile phones and cable TV set-top boxes. The terminal downloads and starts a Java application. It interprets bytecode in a sand-box environment for security reasons. Using bytecodes instead of machine language instructions makes such programs OS (Operating Systems) and CPU (Central Processing Unit) independent. More importantly, using a programming language enables developers to create virtually any applications; developers are only limited by their imagination and the APIs on the device. Using a programming language, non-deterministic concepts such as threads can be used and hence enhance the realism and appeal of contents.

In view of this discussion, it should be apparent that with a programmatic approach, one can create an application that reads textual descriptions, interpret them in the most optimized manner (e.g. just for the commands used in textual descriptions), and use whatever logic see fit for this application. And, in contrary to textual description applications, programmatic applications can evolve over time and maybe located on different locations (e.g. applications may be distributed), independently on each axis:
Data representation
Application logic
Application features (including streaming, user interaction, and so on)
API

For example, a consumer buys a DVD today and enjoys a movie with some menus to navigate in the content and special features to learn more about the DVD title. Over time, the studio may want to add new features to the content, maybe a new look and feel to the menus, maybe allow users with advanced players to have better looking exclusive contents. Today, the only way to achieve that would be to produce new DVD titles. With an API approach, only the logic of the application may change and extra materials may be needed for the new features. If these updates were downloadable, production and distribution costs would be drastically reduced, content would be created faster and consumers would remain longer anchored to a title.

Even though runtime environments require more processing power for the interpreter, the power of embedded devices for multimedia today is not an issue. The APIs available on such systems for multimedia applications is, on the other end, very important. The invention described in this document concerned an extensible, programmatic, interactive multi-media system.

### SUMMARY

In accordance with an embodiment of the invention, a multimedia terminal for operation in an embedded system, includes a native operating system that provides an interface for the multimedia terminal to gain access to native resources of the embedded system, an application platform manager that responds to execution requests for one or more multimedia applications that are to be executed by the embedded system, a virtual machine interface comprising a byte code interpreter that services the application platform manager; and an application framework that utilizes the virtual machine interface and provides management of class loading, of data object life cycle, and of application services and services registry, such that a bundled multimedia application received at the multimedia terminal in an archive file for execution includes a manifest of components needed for execution of the bundled multimedia application by native resources of the embedded system, wherein the native operating system operates in an active mode when a multimedia application is being executed and otherwise operates in a standby mode, and wherein the application platform manager determines presentation components necessary for proper execution of the multimedia applications and requests the determined presentation components from the application framework, and wherein the application platform manager responds to the execution requests regardless of the operating mode of the native operating system.

It should be noted that, although a Java environment is described, any scripting or interpreted environment could be used. The system described has been successfully implemented on embedded devices using a Java runtime environment.

### BRIEF DESCRIPTION OF DRAWINGS

FIG. 1 is a block diagram of a terminal constructed in accordance with the invention.

FIG. 2 is a Typical Player data flow.

FIG. 3 is an example of local/unicast/mulitcast playback data flow (e.g. for IP-based services).

FIG. 4 is the same as FIG. 3 with DOM description replaced by scripted logic.

FIG. 5 is a gigh-level view of a programmatic interactive multi-media system.

FIG. 6 is a multimedia framework: APIs (gray boxes) and components (green ovals). This shows passive and active objects a multimedia application can use.

FIG. 7 is the anatomy of a component: a lightweight interface in Java, a heavyweight implementation in native (i.e. OS specific). Components can also be pure Java. The Java part is typically used to control native processing.

FIG. 8 is a buffer that holds a large amount of native information between two components.

FIG. 9 is an OpenGL order of operations.

FIG. 10 is Mindego framework's usage of OSGi framework FIG. 11 is the bridging non-OSGi applications with OSGi framework.

FIG. 12 is Mindego framework extended to support existing application frameworks. Many such frameworks can run concurrently.

FIG. 13 is Mindego framework support multiple textual description frameworks. Each description is handled by specific compositors which in turn uses shared (low-level) services packaged as OSGi bundles.

FIG. 14 is an application may use multiple scene description.

FIG. 15 and FIG. 16 show different ways of creating applications:

FIG. 17 is two applications with separate graphic contexts.

FIG. 18 is two applications sharing one graphic context.

FIG. 19 is an active renderer shared by two applications.

FIG. 20 is a media pipeline (data flow from left to right). Green ovals are OSGi bundles (or components). The blue oval is provided by the MDGlet application.

FIG. 21 shows buffers controls interactions between active objects such as decoders and renderer.

FIG. 22 is a media API class diagram.

FIG. 23 is the Player and Controls in a terminal.

FIG. 24 is the Mindego controls.

FIG. 25 is an Advanced Audio API. In blue are high-level objects easier to use than the low-level OpenAL wrappers AL and ALC interfaces.

FIG. 26 is the Java bindings to OpenGL implementation.

FIG. 27 is the Command buffer structure. Each tag corresponds to a native command and params are arguments of this command.

FIG. 28 is the API architecture.

FIG. 29 is the sequence diagram for MPEGlet interaction with Renderer.

FIG. 30 is the Scene and OGL API use OpenGL ES hardware, thereby allowing both APIs to be used at the same time.

FIG. 31 is the Scene API class diagram.

FIG. 32 shows the Joystick may have up to 32 buttons, 6 axis, and a point of view.

### DETAILED DESCRIPTION

1 Architecture

1.1 High-Level Design

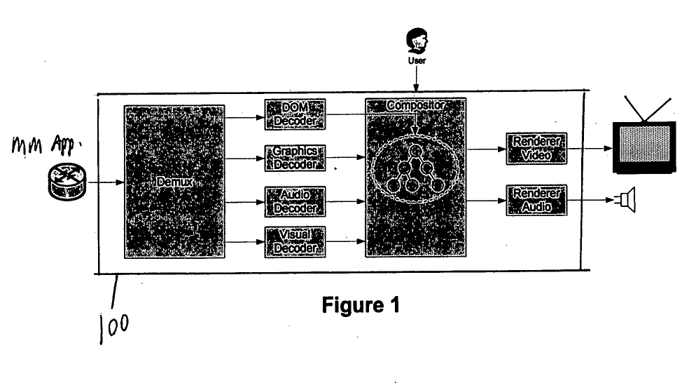

FIG. 1 depicts a terminal constructed in accordance with the invention. It will be referred to throughout this document as a Mindego Multimedia System (M3S) in an embedded device. It is composed of the following elements:
A multitasking operating system of the embedded device 100.
A JVM running on the device 100, configured at least to support Connected Device Configuration and Mobile Information Device Profile.
Mindego Platform (which includes OSGi R3 but preferably R4)
Rendering hardware, such as
   OpenGL 1.3 or 1.5 (see, for example, Silicon Graphics Inc. OpenGL 1.5. Oct. 30, 2003), or OpenGL ES 1.1 (see, for example, Khronos Group, OpenGL ES 1.1. http://www.khronos.org) compliant graphic chip
   At least: audio stereo (preferably multichannel) output and SPDIF output
   S-VHS output, optionally: component output, DVI output
Basic multi-media components, such as
   AVI decoder (see, for example, Microsoft. AVI file format. http://msdn.microsoft.com/library/default.asp?url=/library/en-us/directshow/htm/avifileformat.asp), MP4 (see, for example, ISO/IEC 14496-14, Coding of audio-visual objects, Part 14: MP4file format) demultiplexers
   H.261/3/4 (see, for example, ISO/IEC 11172-3, Coding of moving pictures and associated audio for digital storage media at up to about 1.5 Mbit/s, Part 3: Audio. 1993), MPEG-4 Video (see, for example, Coding of moving pictures and associated audio for digital storage media at up to about 1.5 Mbit/s, Part 3: Audio, supra) support
   MP3 decoder (see, for example, Coding of moving pictures and associated audio for digital storage media at up to about 1.5 Mbit/s, Part 3: Audio, supra), AAC (see, for example, ISO/IEC 14496-3, Coding of audio-visual objects, Part 3: Audio), WAV audio support
   XML support (see, for example, W3C. eXtensible Markup Language (XML))
Ethernet adapter, such as for
   TCP (see, for example, RFC 1889, RTP: A transport protocol for real-time applications, January 1996)/IP (see, for example, RFC 2326, RTSP: Real Time Streaming Protocol, April 1998), UDP (see, for example, RFC 768, UDP: User Datagram Protocol, August 1980), RTP (see, for example, RFC 1889, RTP: A transport protocol for real-time applications, January 1996, supra)/RTSP (see, for example, RFC 2326, RTSP: Real Time Streaming Protocol, April 1998) protocols support
Flash memory for persistent storage of user preferences.
   Optionally, the terminal may have
MPEG-2 TS (e.g. TV tuner and/or DVD demux)
Audio/video encoders and multiplexers for video encoding and streaming
UPnP (see, for example, Universal Plug and Play (UPnP). http://www.upnp.org) support for joysticks, mouse, keyboards, network adapters, etc.)
USB 2 interface (see, for example, Universal Serial Bus (USB). http://www.usb.org) (to support mouse, keyboard, joysticks, pads, hard disks, etc.)
Hard disk
DVD reader
Multi Flash card reader and smart card reader

The last three items may not be included as USB support enables users to add these features to the terminal from third party vendors.

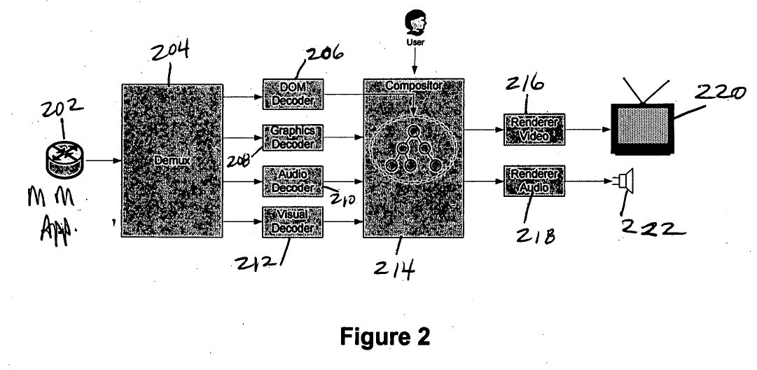

FIG. 2 depicts the data flow in a typical player. The scene description is received in the form of a Document Object Model (DOM). Note that in computer graphics, it is often called a scene and, with the advent of web pages and XML, the term DOM once reserved to describe web pages has been extended to encompass any tree-based representation. The DOM may be carried compressed or uncompressed, in XML or any other textual description language. For web pages, the language used is HTML, for MPEG-4 (see, for example, Coding of moving pictures and associated audio for digital storage media at up to about 1.5 Mbit/s, Part 3: Audio, supra) it is called BIFS (see, for example, Coding of moving pictures and associated audio for digital storage media at up to about 1.5 Mbit/s, Part 3: Audio, supra), for 3D descriptions, VRML (see, for example, ISO/IEC 14772, Virtual Reality Modeling Language (VRML) 1997 http://www.web3d.org/x3d/specifications/vrml/) or X3D (see, for example, ISO/EC 19775, eXtensible 3D (X3D). 2004. http://www.web3d.org/x3d/specifications/x3d/specification.html) or Collada (see, for example, Collada. http://www.collada.org) or U3D (see, for example, World-Wide Web Consortium (W3C). Scalar Vector Graphics (SVG)) may be used, for 2D descriptions, SVG (see, for example, World-Wide Web Consortium (W3C). Scalar Vector Graphics (SVG), supra) may be used, and so on. The main characteristic of a DOM is to describe the assembly of various media objects onto the screen of the terminal. While the description is often visual and static, advanced DOM may be dynamic (i.e. evolve over time) and may describe audio environment. Dynamic DOMs enable animations of visual and audio objects. If media objects have interactive elements attached to their description (e.g. the user may click on them or roll-over them), the content become user driven instead of being purely data driven where the user has no control over what is presented (e.g. as it is the case with TV-like contents). The architecture described in this document enables user-driven programmatic multi-media applications.

The architecture depicted in FIG. 2 is made of the following elements:
Network or local storage 202—a multimedia application and all its media assets may be stored on the terminal local's storage or may be located on one or more servers. The transport mechanism used to exchange information between the terminal (the client) and servers is irrelevant. However, some transport mechanisms are more suited from some media than others.
Demultiplexer 204—while multiple network adapters may be used to connect to the network, terminals typically have only one network adapter. Therefore all media are multiplexed at the server and must be demultiplexed at the terminal. Likewise, packets from different media that must be presented at similar times are time multiplexed. Once demultiplexed, packets of each stream are sent to their respective decoders and must be decoded at the decoding time stamp.
Decoders—a decoder transforms data packets from a compressed representation to a decompressed representation. Some decoders may just be pass-through as it is often the case with web pages. Decoder output may be a byte array (e.g. in case of audio and video data) or a structured list of objects (e.g. typically the case with synthetic data like vector graphics or a scene graph like a DOM). Decoders can included DOM 206, graphics 208, audio 210, and visual 212.
Compositor 214—From a DOM description, the compositor mixes multiple media together and issues rendering commands to a renderer
Renderer—a visual renderer 216 draws objects onto the terminal's screen and an audio renderer 218 renders sound to speakers. Of course, other types of renderers can be used (printers, lasers, and so on) but screen 220 and speakers 222 are the most common output forms.
User—the user interacts with the system via the compositor to provide input commands.

FIG. 2 depicts typical playback architecture but it doesn't describe how the application arrives and is executed on the terminal. There are essentially two ways:
Broadcast—The terminal listens to a particular channel and waits until a descriptor signals an application is available in the stream. This application can be a simple video and multiple audio streams (e.g. a TV channel) or can be more complex with a DOM or with bytecode. Once the application is started, it connects to the streams that provide its necessary resources (e.g. audio and video streams). In the case of TV broadcasting, the network element can be replaced by a MPEG-2 TS demultiplexer (to choose the TV channel) and the Demux enables demultiplexing of audio-visual data for a particular channel.
Local or download—The terminal requests a server to send a file that describes an application. Once this application is downloaded, it may request the terminal to ask for resources on the same or on different servers and different protocols may be used depending on resilience and QoS needed on the streams. Once the connection is established between one or more servers and the terminal, the application behaves as in the broadcast case.

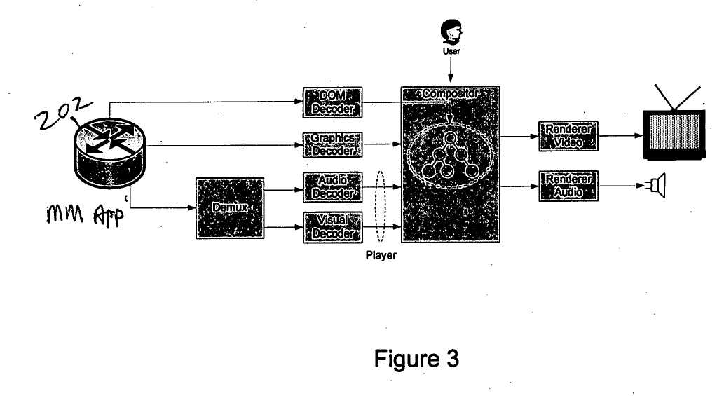

FIG. 3 shows an alternative representation of FIG. 2. In this figure, the network adapter behaves like a multiplexer and media assets with synchronized streams (e.g. a movie) may use a multiplexed format. In this case, we say that a player manages such assets and one could say that a multimedia application manages multiple players.

FIG. 3 is often found on IP-based services such as web applications and it should be clear that the network could also a file on the local file system of the terminal. The architecture of FIG. 2 is typically found in broadcast scenari. One of the advantage of FIG. 3 is for applications to request and to use media from various servers, which is typically not possible with broadcast scenari.

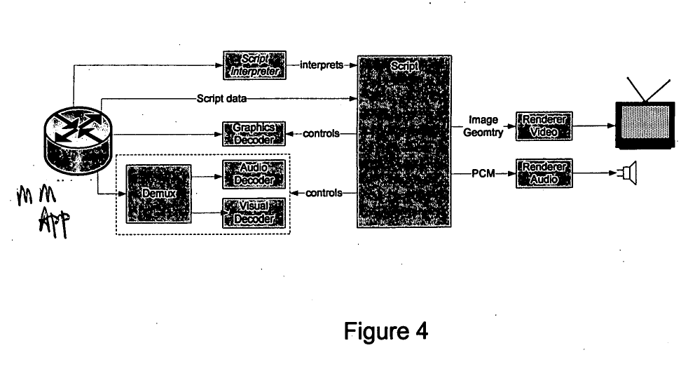

Instead of DOM descriptions, scripted logic may be used. FIG. 4 shows a terminal with pure scripted logic used for applications. By pure we mean that no DOM is used as the central application description because otherwise using scripts simply modifies the DOM. In the case of purely scripted applications, the script communicates with the terminal via Application Programming Interfaces (APIs). The script defines its own way to compose media assets, to control players, to render audio-visual objects on the terminal's screen and speakers. This approach is the most flexible and generic and the one used in this document since it also enables usage of any DOM by simply implementing DOM processors in the script and the DOM description to be one type of script's data.

1.2 Concepts

Following is a description of concepts useful in understanding systems and methods in accordance with the present invention.

1.2.1 Application Logic and Composition

In a video, images evolve over time. Likewise, a vector graphics cartoon evolves over time to produce an animation. Likewise, the DOM may evolve over time to change the topology of the scene description and hence the screen composition. Changing composition in response to events is the essence of application's logic.

In a multi-media system, events may come from various sources:
Media stream—data packets contain commands that modify composition
User interaction—if user interacts with object X, execute command Y
Static logic—at time X, execute command Y
Dynamic (behavioral) logic—depending on various criterions, execute command

Behavioral logic is probably the most used in applications that need complex user-interaction e.g. in games: for example, if the user has collected various objects, then a secret passage opens and the user can collect healing kits and move to the next game level. Static logic or action/reaction logic is used for menus and buttons and similar triggers: user clicks on an object in the scene and this triggers an animation. Media stream commands are similar to static logic in the sense that commands must be executed at a certain time. In a movie, commands are simply to produce the next images but in a multi-user environment, commands may be to update the position of a user and its interaction with you; this interaction is highly dependent on the application's logic, which must be identical for all users.

Early systems were limited to few built-in commands and players' compositors were restricted to understand only these commands. Using scripting languages, programmers can develop their own composition as long as they have access to the renderer. Any scripting language and renderer can be used. However, the most widely available in the market are:
Scripting: ECMAScript (see, for example, ECMA-262, ECMAScript) (and derivatives), Java (see, for example, J. Gosling, B. Joy and G. Steele. The Java Language Specification, Addison-Wesley, September 1996. ISBN 0-201-63451-1)
Renderers:
   Video: OpenGL (see, for example, Silicon Graphics Inc. OpenGL 1.5. Oct. 30, 2003) (see, for example, Khronos Group, OpenGL ES 1.1. http://www.khronos.org, supra), M3G (see, for example, Java Community Process, Mobile 3D Graphics 1.1, Jun. 22, 2005. http://jcp.org/aboutJava/communityprocess/final/jsr184/index.html), DirectX (although only on Microsoft Windows machines)
   Audio: OpenAL (see, for example, Creative Labs. OpenAL. http://www.openal.org) used in our architecture can be implemented on top of any audio device.

ECMAScript is a simple scripting language useful for small applications but very inefficient for complex applications. In particular, ECMAScript does not provide multithreading features. Therefore, non-deterministic behavior necessary for advanced logic can only be simulated at best and programmers cannot use resources efficiently either using multiple threads of controls or multiple CPUs if available. Java language is preferred for OS and CPU independent applications, for multithreading support, and for security reasons. Java is widely used on mobile devices and TV set top boxes. Scripting languages require an interpreter that translates their instructions into opcodes the terminal can understand. The Java language uses a more optimized form of interpreter called a Virtual Machine (VM) that runs in parallel with the application. While the description of the invention utilizes Java, similar scripting architecture can be used such as Microsoft .NET, Python, and so on.

OpenGL (see, for example, Khronos Group, OpenGL ES 1.1. available at http://www.khronos.org, supra) (see, for example, Silicon Graphics Inc. OpenGL 1.5. Oct. 30, 2003, supra) is the standard for 3D graphics and has been used for more than 20 years on virtually any type of computer and operating system with 3D graphic features. DirectX (see, for example, DirectX developer documentation. http://msdn.rnicrosoft.com/library/default.asp?url=/library/en-us/dnanchor/html/anch_directx.asp) is developed by Microsoft and is available only on machines with Microsoft OS. Other renderers have emerged over the years and are higher level than these renderers, such as M3G. Higher-level renderers are typically easier to program but tend to be designed for specific applications and most developers prefer lower-level renderers so they can control higher-level features built upon lower-level ones specifically for their applications (e.g. as it is commonly in the game industry). It is interesting to note that no 2D API has become a standard to date except maybe Java 2D. Recently OpenVG (see, for example, Khronos Group, Open VG. http://www.khronos.org.) (built upon OpenGL foundations) has the potential of becoming a standard 2D API for mobile phones.

Therefore, on embedded systems, OpenGL and Java are dominant and they will be used to describe the invention therein (but it should be clear that any other scripting language and renderer can be used today or in the future).

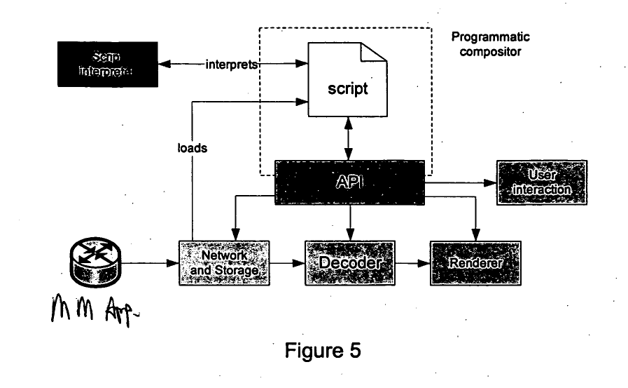

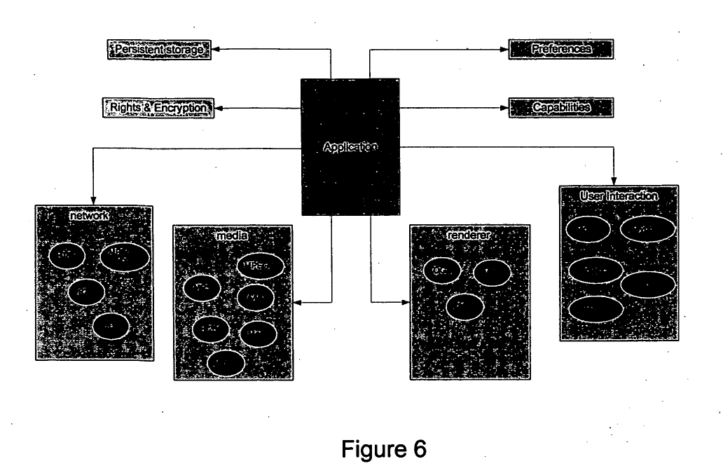

In FIG. 5, an application's logic (script) is loaded and interpreted by its script interpreter also referred to as a byte code interpreter. Meanwhile, audio-visual decoders may decode data packets as they are demultiplexed. When the script is interpreted, it uses an API to communicate with the terminal, thereby shielding the script from accessing terminal resources for security. The script can now control:
Network or storage operations by opening a channel to a location described by a Uniform Resource Locators (URL).
Decoder processing to start/stop/pause/seek
Rendering operations to produce interesting audio-visual effects
User interaction devices to communicate with a user such as keyboard, mouse, joysticks, remote controls, data glove and so on.

By opening network channels, a script is also able to receive data packets and to process them. In other words, parts of the script may act as decoders. Moreover, a script may be composed of many scripts, which may be downloaded at once or progressively.

Along with the application's scripts, an application descriptor is used to inform the terminal about which script to start first. The interpreter then looks in the script for specific methods that are executed in a precise order; this is the bootstrap sequence. If the application is interrupted by the user, by an error, or ends normally, a precise sequence of method calls is executed by the interpreter, mainly to clean up resources allocated by the application; this is the termination sequence. Once an application is destroyed, all other terminal resources (network, decoder, renderer and so on) are also terminated. While running, an application may download other scripts or may have its scripts updated from a server.

1.2.2 Separation of Concerns and Components

A multi-media system is composed of various sub-systems, each with separate concerns. In this document, we are interested with multi-media applications downloaded from servers and executed on terminals. It is crucial that these applications use the same API and this API to be available on all terminals.

As shown in FIG. 5, the script interpreter shields the application from the terminal resources for security reasons. The script interpreter runs in a sand box model so that whatever error, exception, malicious usage, and so on, happens in a protected area of the machine:
if the application crashes, the terminal doesn't crash but in this protected area, everything is destroyed
if the application tries to access protected resources, the interpreter can cancel the requests
the script language is OS and CPU independent
the script interpreter imposes a little overhead and uses few terminal resources
the script interpreter provides support for multithreading

To date, the most used and robust interpreter with such features is the Java Virtual Machine (JVM) and in particular with its profiles and configurations for embedded devices (e.g. MIDP (see, for example, Java Community Process, Mobile Information Device Profile 2.0, November 2002, http://www.jcp.org/en/jsr/detail?id=118)/PBP (see, for example, Java Community Process, Personal Basis Profile 1.1, August 2005, http://www.jcp.org/en/jsr/detail?id=217, supra)/PP (see, for example, Java Community Process, Personal Profile 1.1, August 2005, http://www.jcp.org/en/jsr/detail?id=216)/FP (see, for example, Java Community Process, Foundation Profile 1.1, August 2005, http://www.jcp.org/en/jsr/detail?id=217) profiles, CLDC (see, for example, Java Community Process, Personal Basis Profile 1.1, August 2005, http://www.jcp.org/en/jsr/detail?id=219)/CDC (see, for example, Java Community Connected Device Configuration, August 2005, http://www.jcp.org/en/jsr/detail?id=218) configurations). The interpreter already comes with built-in libraries (or core API) depending on the profiles and configurations chosen. In this document, we use features that require at least MIDP 2.0 and CDC 1.0.

In addition to the core API, this document defines APIs specific to multi-media entertainment systems and each API has specific concerns. The essence of the invention is the usage of all these APIs for a multimedia system as well as the particular implementation that makes all these APIs work together and not as separate APIs as it is often the case to date. The concerns of each API are as follows:
Network—Uniform Resource Identifiers (URIs) are used to refer to any resource. URIs follow RFC 2396 (see, for example, RFC 768, UDP: User Datagram Protocol, August 1980, supra) in the form <scheme>:<scheme-specific-part>. Other RFCs describe <scheme> and their specific parts. The terminal must at least implement HTTP scheme.
Media—the terminal may support one more audio-visual codecs, text and font codecs, image codecs, synthetic codecs (e.g. vector graphics, animation, metadata, and so on). Each codec is controllable via controls and each codec may expose codec-specific controls.
   Notes:
   A (de)multiplexer is also a codec and hence may expose specific controls.
   Digital Rights Management systems are also codecs.
   A transport stream is modeled as a demultiplexer of demultiplexers (e.g. cable TV is demuxed into TV channels that are themselves demuxed into audio-visual streams).
Renderer—a renderer renders something on an output device, which can be a display, a printer, a speaker and so on. In this document, we will refer to the terminal's display.
Persistent storage—applications need to store persistent data that would remain across execution of the same application. The storage may be a file, a memory card, etc. and information may be encrypted or not.
User interaction—a user may interact with the terminal and an application using devices such as keyboard, mouse, gloves etc.
Preferences—users may customize the terminal (e.g. look and feel, updates, parental control, etc.) and applications may query terminal capabilities (e.g. CPU, speed, OS, network scheme/codecs/renderer available, etc.)
Application API—this API enables the bootstrap of downloaded applications, which in turn may use the other APIs. Applications must run in their own namespace (i.e. in their own Java classloader), which must not be one used by the terminal, for security reasons.

It should be clear that each API provide generic interfaces to specific components and these components can be updated at any time, even while the terminal is running. For example, the terminal may provide support for MP3 audio and MPEG-4 Video. Later, it may be updated to support AAC audio or H.264 video. From an application point of view, it would be using audio and video codecs, regardless of the specific encoding. The separation of concern in the design is crucial in order to make a lightweight yet extensible and robust system of components.

This is a fundamental difference between our architecture (which is a framework) versus APIs. APIs are essentially a clever organization of procedures that are called by an application. With a framework, many active and passive objects can assist an application, run in separate namespaces and separate threads of execution, or even be distributed. Our framework is always on, always alive (the script interpreter is always running) unlike APIs that becomes alive with an application (the script interpreter must be restarted for each application).

Finally, it is worth noting that, in this design, applications are simply extensions of the system; they are a set of components interacting with other components in the terminal via interfaces. Since applications run in their own namespace and in their own thread of execution (i.e. they are active objects), multiple applications can run at the same time, using the same components or even components with different versions and hence components can be updated at any time.

For these reasons, we chose the Open Service Gateway Platform (OSGi) for the application management within Mindego framework. The virtual machine required for OSGi is a Connected Device Configuration (CDC) virtual machine, while many mobile phones today used the limited configuration (CLDC). However, the need for a service platform that is scalable, flexible, reliable, and with a small footprint is making mobile phone manufacturers chose OSGi for their next generation devices.

It should be noted that CLDC 1.1 misses one crucial feature: class loaders (for namespace execution paradigm), that forces usage of the heavier CDC virtual machine.

1.2.2.1 Components

A component is a processing unit. Components process data from their inputs and produce data on their outputs; they are Transformers. Outputs may be connected to other components; those with no output are called DataSinks. Some autonomous (or active) components may not need input data to generate outputs; they are DataSources.

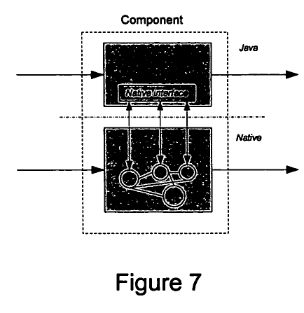

Our framework is full of components, which can be written in pure Java or be a mixture of Java code and natively optimized code (i.e. OS specific). Heavy processing components such as codecs, network adapters, and renderers consist of a Java interface wrapping native code, as depicted on FIG. 7.

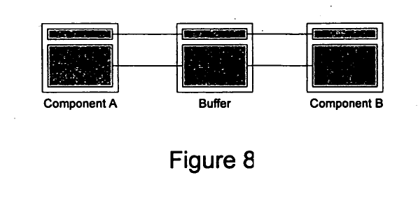

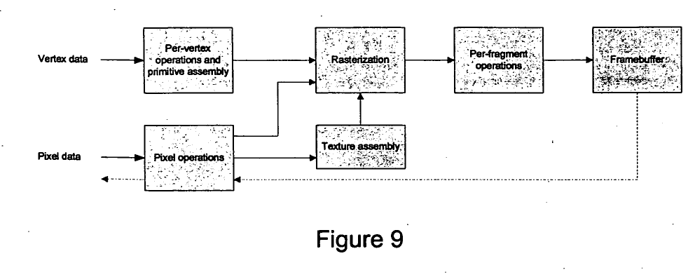

Typically, input messages are received by the component at the Java layer and commands are sent to the native layer to execute some heavy processing (possibly hardware assisted). Upon return of the native processing, the Java layer may send results to other components. However, when large amount of information is processed, it would be too slow to transfer such information back and forth the 2 layers. In this case, an intermediate object is used: the native Buffer object (FIG. 8), see section 1.5.2.

A native Buffer object (NBuffer) is a wrapper around a native area of memory. It enables two components to use this area of memory directly from the native side (the fastest) instead of using the Java layer to process such data. Likewise, this data doesn't need to be exposed at the Java layer, thereby reducing the amount of memory used and accelerating the throughput of the system.

1.2.3 Rendering

In most audio-visual applications, rendering operations consists of graphic commands that draw something onto the terminal's screen. The video memory, a continuous area of memory, is flushed to the screen at a fixed frame rate (e.g. 60 frames per second). For 2D graphics, the operations are simple and no standard API exists but all OS and scripting languages provide similar features. In 3D, rendering operations are more complex and OpenGL is the only standard API available on many OS. Today, OpenGL ES, a subset of OpenGL is now available on mobile devices.

However, OpenGL is a low-level 3D graphics API and more advanced, higher-level APIs may be used to simplify application developments: Mobile 3D Graphics (M3G), Microsoft DirectX, and OpenSceneGraph are examples of such APIs.

The proposed architecture supports multiple renderers that applications can select at their convenience. These renderers are all OpenGL-based and renderer interfaces available to applications range from Java bindings to OpenGL to bindings to higher-level APIs.

Using 2D or 3D architectures is fundamentally different:
in 2D, video operations happen in main memory
in 3D, video operations happen in a 3D hardware accelerator (or 3D card) i.e. not in main memory

Therefore, with 3D cards, huge amount of data must be transferred from computer's memory to the card's memory (an acceleration is to use shared memory). Likewise, drawing operations do not happen in memory but in the 3D card's memory, which typically runs faster than main memory. Hence, compositing and rendering operations are buffered. This enables many effects not possible with 2D architectures:
hardware optimized operations
data can be cached on the 3D card (e.g. textures)
video data can be transmitted asynchronously to buffer's in the card and reused for texturing/blending operations
many special rendering effects can be hardware accelerated
a 3D card is in essence another component in the architecture that can evolve separately from other components
it is interesting to note that a new 2D hardware accelerated vector graphics standard—Open VG—is emerging and is based on OpenGL so that 2D and 3D commands can be handled by one OpenGL engine.
   1.2.4 Concept Summary

Our system is mostly an extensible, natively optimized framework with many components that can be updated at any time, even at runtime. A lightweight Java layer enables applications to control the framework for their needs and for the terminal to control liveliness and correctness of the system.

The Java interfaces used in our system have specific behaviors that must be identical on all OS so that applications have predictable and guaranteed behaviors. Clearly, implementations of such behaviors vary widely from one OS to another. In order to simplify porting the system from one OS to another, we only specify low-level operations.

1.3 Sequence of Operations

The sequence of operations is as follows:
1. The terminal is powered on
2. BIOS and Operating system (OS) start
3. OS launches Mindego Platform
4. Mindego Platform launches the main application i.e. Mindego Player that enables users to customize the player, select media assets to be played, and so on.
5. If Mindego Platform had a previous state saved, it is reloaded, which may re-launch previous applications
6. User selects an application (MDGlet)
7. Mindego Platform download the MDGlet from local storage or from a server
   a. Mindego Platform resolves components and services dependencies
   b. Mindego Platform launches the MDGlet
8. If an error occurs, Mindego Platform destroys the application
9. If user switches to another application, the Mindego Platform stops the MDGlet (which may trigger the MDGlet to store its state)
10. If the user destroys the MDGlet, the Mindego Platform destroys the application and reclaims all its resources.
11. If the terminal is powered off
   a. Mindego Platform stops all running MDGlets (which may trigger MDGlets to store their state)
   b. Terminal stops Mindego Platform (which may save some state information)
   c. OS shutdown
   d. Terminal is off.
      1.4 Always On

Following the sequence of operations described in section 1.3, the Mindego Player—the user interface to the Mindego Platform—is always running and waiting to launch and to update applications, to run applications, or to destroy applications.

An application may have a user interface or not. For example, watching a movie is an application without user interface elements around or on the movie. More complex applications may provide more user interface elements (dialog boxes, menus, windows and so on) and rich audio-visual animations.

Since the platform is always on, any applications on the terminal is an application developed for and managed by the Mindego Platform.

1.5 Detailed Architecture

In order to maximize interoperability, many existing APIs are reused
Open Service Gateway Initiative (OSGI) (see, for example, OSGi Consortium, Open Service Gateway Initiative (OSGi) specification R3. http://fwww.osgi.org)—an optimal Java-based application server platform. OSGi requires CDC virtual machine.
JSR-36/JSR-218 Connected Device Configuration (CDC) 1.0/1.1—It standardize a highly portable, minimum footprint Java™ application development platform for resource-constrained, connected devices. CDC augments CLDC with floating-point, weak references, reflection, Java Native Interface (JNI), and namespace support (class loaders).
JSR-118 Mobile Information Device Profile (MIDP) 2.0—MIDP defines device-type-specific sets of APIs for mobile market. This profile defines a minimal user graphical interface, the Record Management System (RMS) for persistent storage, and support for HTTP/HTTPS and UDP protocols within CDC's Generic Connection Framework (GCF). Other profiles than MIDP can be used such as Personal Basis Profile (PBP) or Personal Profile (PP) that provides additional features.
JSR-135 Mobile Multimedia API (MMAPI)—provides a generic and minimal framework for multimedia services with a high-level object-oriented approach. This API provides the necessary abstraction for Players (that play contents) and Controls (that control the playback). Our implementation provides support for many network protocols and audio-visual codecs. We also define special controls for vertical markets such as DVDs.
JSR-239 Java bindings to OpenGL ES—provides possibly hardware accelerated vector graphics based on industry standard OpenGL ES API.

Higher-level configurations and profiles may be used for machine with more resources; for example, JSR-218 Connected Device Configuration (CDC), which augments CLDC 1.1, or JSR-217 Personal Basis Profile (PBP), which augments MIDP features (but application management is not the same e.g. MIDlet vs. Xlet).

While a profile is necessary to have a working implementation of Java for a vertical market, the architecture described herein doesn't rely on a specific profile because our framework executes applications called MPEGlets that, albeit similar to MIDlets/Xlets/Applets, have their own application environment. Therefore, only the configuration of the virtual machine is essential and all other audio-visual objects can be implemented using the renderers described in this document.

In fact, in our implementation, our terminal is a particular Java profile's application e.g. it is a MIDlet, an Xlet, or an Applet that waits for arrival and execution of MPEGlet applications.

Therefore, it is possible to define another Java profile just for MPEGlets in order to have a more optimized terminal. The only requirements are:
Support for a drawing area e.g. Display and/or Canvas (so renderers can draw onto it)
Support for socket based communication
Support for persistent storage (e.g. MIDP's Record Management System)
   1.5.1 Application Management

Our framework uses the OSGi framework to handle the life cycle management of applications and components.

On limited resources devices, the CLDC version of the JVM could be used to implement OSGi framework but proper handling of versioning and shielding applications from one another would not be possible.

Within OSGi framework, an application is bundled in a normal Java ARchive (JAR) and its manifest contains special attributes the OSGi application management system will use to start the applications in the archive and retrieve the necessary components it might need (components are themselves in JAR files). OSGi specification calls such package a bundle.

The OSGi framework can also be configured to provide restricted permissions to each bundle, thereby adding another level of security on top of the JVM security model. The OSGi framework also strictly separates bundles from each other.

One of the key features of the OSGi framework compared to other Java application server models (e.g. MIDP, J2EE, JMX, PicoContainer etc.) is that applications can provide functions to other applications, not just use libraries from the run-time environment; in other words, applications don't run in isolation. Bundles can contribute code as well as services to the environment, thereby allowing applications to share code and hence reduce bundle size and hence download time. In contrast, in the closed container model, applications must carry all their code. Sharing code enables a service-oriented architecture and the OSGi framework provides a service registry for applications to register, to unregister and to find services. By separating concerns into components mobile applications becomes smaller and more flexible. With its dynamic nature, the OSGi framework enables developers to focus on small and loosely coupled components, which can adapt to the changing environment in real time. The service registry is the glue that binds these components seamlessly together: it enables a platform operator to use these small components to compose larger systems (see, for example, OSGi Consortium, Open Service Gateway Initiative (OSGi) specification R3. http://www.osgi.org, supra).

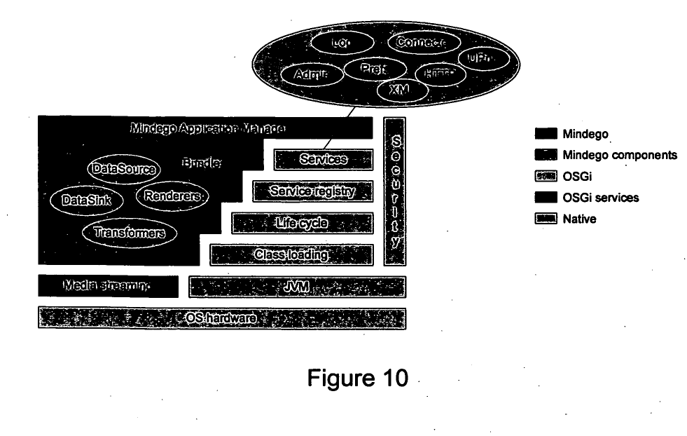

The Mindego Application Manager bootstraps the OSGi framework, control the access to the service registry, control permissions for applications, and binds non-bundles applications (e.g. MPEGlets) to the OSGi framework. This enables us to have a horizontal framework for vertical products. FIG. 10 shows the various components of the framework:
OSGi services
Mindego framework multimedia-specific bundles:
   DataSources: file and transport stream parsers
   DataSinks: file and transport stream writers
   Transformers: encoders, decoders, multiplexers, demultiplexers, filters
   Renderers: OpenGL or other rendering API wrappers

Mindego bundles follow FIG. 7: they are heavyweight components with many native optimizations and little Java code. For proper media synchronization, these bundles are part of a streaming framework whose media API (section 1.5.4) is a partial exposure.

In our framework, we are interested in managing typical Java applications such as MIDlets, Xlets, Applets, and MPEGlets. We are interested in applications such as Xlets and MPEGlets because they favor the inversion of control principle and communicate with their application manager via a context. So to be generic we call such applications MDGlets and their contexts MDGletContext. A context encapsulates the state management for a device (e.g. rendering context) or an application (e.g. MDGlet context).

An MDGlet is similar to an OSGi bundle: it is packaged in a JAR file and may have some dedicated attributes added to the manifest file for usage by the Application Manager i.e. the MDGletManager. However, an MDGlet has no notion of services and hence cannot interact with the OSGi framework. The Mindego Application Manager acts as an adapter to the OSGi framework:
It loads and binds the necessary services an MDGlet request
It manages the life cycle of an MDGlet
It ensures an MDGlet runs in its own namespace (and shields it from other MDGlets and from the rest of the system)
It ensures bundle updates do not interfere with MDGlets
Each MDGlet has its own context MDGletContext to dialog with the application manager.

FIG. 11 depicts how non-OSGi applications are bound to the OSGi framework. Mindego Application Manager uses an MDGletContext object to maintain state information of each MDGlet. The Mindego Application Manager communicates with the OSGi framework for the necessary services the MDGlet may require. Such services may be installed as Bundles and communicate with the OSGi framework via BundleContext. In other words, the Mindego Application Manager also acts as a special Bundle for non-OSGi compliant applications.

This design enables mobile applications (MIDlets), set-top box applications (Xlets), and next-generation applications to run on the same framework. More importantly, it enables a new type of applications packaged as Bundles that can take full advantage of the platform without the need of an adapter like the Mindego Application Manager.

1.5.1.1 Support for Legacy Java Application Framework

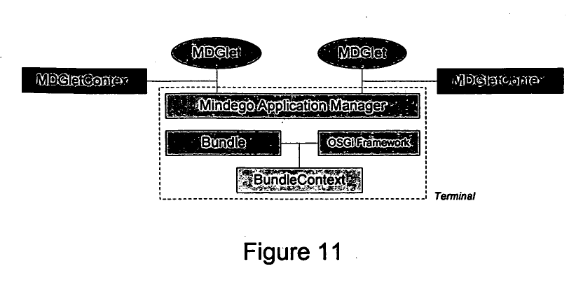

Given the previous description, it should be clear that any application framework can be rewritten using Mindego Application Manager extended to support the requirements of such frameworks, see FIG. 12.

The advantages of using such architecture are:
Reuse of existing applications written for other frameworks
Seamless and transparent use of Mindego framework by applications (i.e. they perceive Mindego framework as the framework they were originally written for)
Framework is always on: no need to restart
Framework and components/services can be updated at run-time whether they are pure written in Java or contains native code
Faster time to market: components/services/applications can be released incrementally and by pieces
Multiple applications can run concurrently without interfering with one another
Fine grained security policy
Remote administration of the framework and applications (if needed)
New types of applications can be created:
   Applications with many components that can be independently updated
   Smaller updates, faster releases
      The disadvantages are:
A slightly bigger memory footprint (both in ROM and RAM) than existing mobile phones virtual machines environment.
Potentially more runtime memory usage (i.e. in RAM) than existing mobile phones environments.
   1.5.1.2 Support for Script-Based Application Framework

With the advent of XML (see, for example, W3C. eXtensible Markup Language (XML), supra), many formats got updated with XML and ECMAScript (see, for example, ECMA-262, ECMAScript, supra). This is the case of all Web applications and services, DVD-Forum's iHD specification for next generation DVDs with advanced interactivity, Sony's Collada, Web3D's X3D specification, W3C's SVG and SMIL, and MPEG's MPEG-4 XMT, MPEG-7 and MPEG-21 standards, among others.

Using a textual description approach instead of a programmatic approach, in theory, provides easier to author and to maintain contents albeit with less features. The number of features is typically limited by applications envisioned by the creator the description but also by the language itself: XML is good at annotating documents but expressing logic of multimedia content is another story and this is why scripting has been added (often ECMAScript).

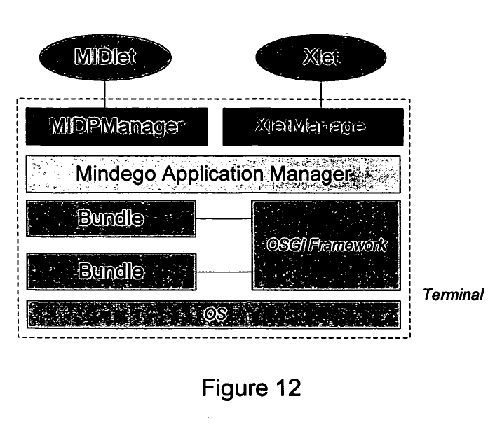

To support such descriptions, we only need to write a dedicated parser and interpreter. For rendering, an optimized compositor is required; it is optimized in the sense that it is built specifically for the features in the language. In other words, we build a description-specific MDGlet application or even bundle. Since all these languages reuse similar features, we package features as bundles and the MDGlet asks the framework for the features (i.e. bundles) it needs, which in turn might be downloaded and updated by the framework. As a result, when a new feature is available it benefits all descriptions that use it. FIG. 13 shows the architecture of the system: each description (e.g. iHD, SVG, X3D, Collada) has its own compositor that uses Mindego Core services and services of other components.

1.5.1.3 Combining Application-Level Descriptions

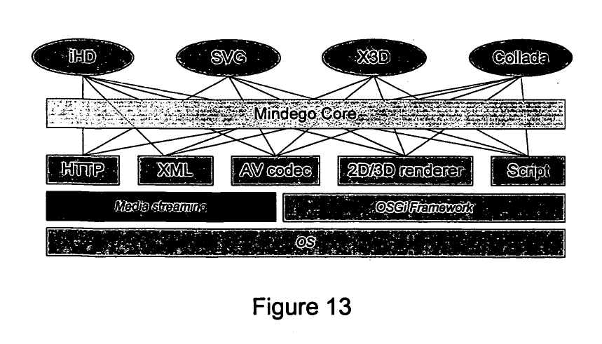

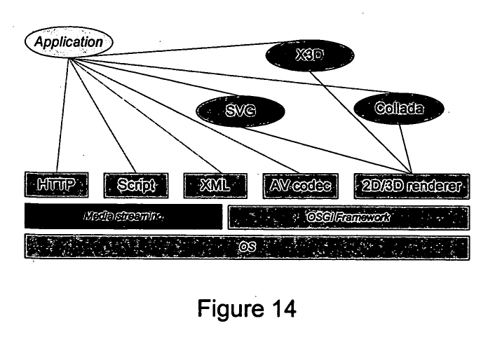

Another benefit of this approach is the possibility for applications to use multiple descriptions. As shown in FIG. 14, an application may use compositors for each description but the application must manage composition since rendering command order is of important and hence all compositors must use the same renderer.

Layered composition is very useful since it enables multimedia contents to be split into parts. And each part may now become a bundle with its own services and resources (e.g. images, video clips and so on), each part may reside in different locations and hence be updated independently.

1.5.1.4 Extensible Applications

In any object-oriented programming language, it is possible to program with interfaces. An interface describes the methods (or services) an object provides. Different objects may provide different implementation of the same interface.

Likewise, it is possible to create multimedia content with interfaces:
A content may use empty areas with specific behavior
Extension bundles may extend the content with implementation of this behavior

This enables update of the implementation of the content independently of its logic and independently of the master content that uses the implementation bundles. Using this philosophy, multimedia applications can be authored with much more flexibility than before, favoring reuse, repurpose, and sharing of media assets and logic.
In Figure, a parent application uses sub-applications. This is similar to a web page having a Flash content or a video playing in the page
In Figure, a parent application has placeholders for extensions. Without extensions, the content continues to work but with extensions, alternate contents are possible. To our knowledge, there is no example of such multimedia contents but in terms of applications with a plug-in architecture.

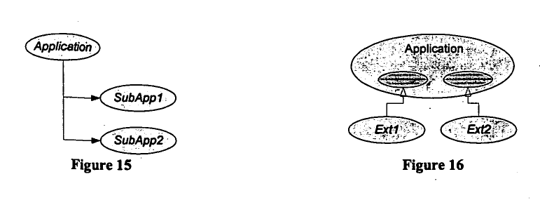

FIG. 16 describes a very interesting application authoring scenario that enable multiple content creation teams to work in parallel and hence reduce content time to market. In plug-in architectures, a program may have place holders for plug-ins. If plug-ins are available the program may offer additional features. If no plug-in is available then the program can still work without extra features. Likewise, contents can be authored and delivered in pieces. Authoring contents in pieces enables a director to create a skeleton of an application with basic behavior then to ask possibly multiple teams to realize portions of the skeleton in parallel and the draft application become alive as sub-contents are being made.

1.5.1.5 Sharing Services

In the proposed framework, multiple applications can run concurrently. However, some services may not be shared. This is the reason why applications are run in separate namespace i.e. by using a separate Java ClassLoader for each one. However, this creates a logical separation but not necessarily a physical one i.e. native code or hardware devices may remain unique. Therefore, it is important that all services be reentrant and thread-safe (e.g. they must support multithreading). This is easy to achieve in software but hardware drivers may not provide such support and a software interface is required for thread synchronization.

For example, two applications may use the service of a renderer to draw on the terminal's screen. From each application point of view, they use a separate renderer object but each renderer uses a unique graphic card in the terminal. Since the card maintains a graphic context with all the rendering state, each application must have its own graphic context or share one with one another. Also, since each application is an active object—it runs in its own thread of control—the graphic context can only be valid for one thread of control.

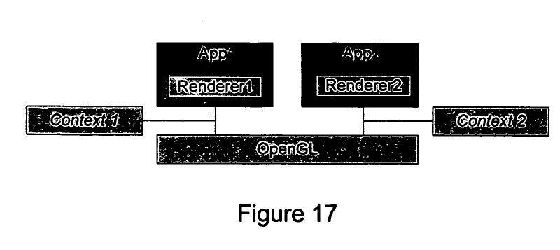

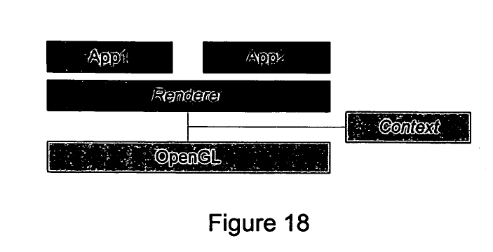

As a result, two applications can share the renderer service if:
1. Each application has a graphic context for its own (rendering) thread of control (FIG. 17),
2. Or, both applications share the service of a unique renderer in its thread of control (FIG. 18).

Case 1 is possible if each application has its own window. But, in general, for TV-like scenarios, only one window is available so case 2 applies. Since case 1 is not an issue, in the reminder of this section we will describe case 2.

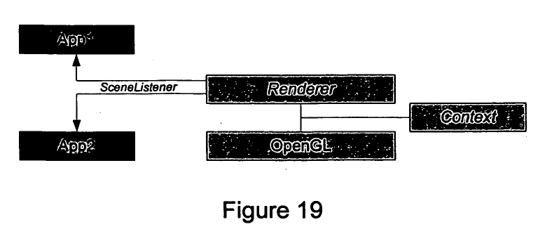

Sharing one graphic context as in case 2 (FIG. 18) between 2 threads of control requires some synchronization between both applications. If one application controls the other then it is as if both applications belong to a parent content and hence there is no issue since this is like authoring one unique application. However, if both applications run concurrently without knowledge of other applications then we have race conditions and possibility of hardware crash. FIG. 19 shows a solution where the renderer is a separate active component that calls applications registered as SceneListeners. Unlike FIG. 17 and FIG. 18 where applications own a rendering thread of control, in FIG. 19, the terminal owns the rendering thread of control. Of course, this scenario can also be implemented by an application that spawns three threads: one for the renderer, and one for each active rendering object. The SceneListener mechanism is part of the SceneController pattern describes in patent Ser. No. 10/959,460.

1.5.1.6 Explicit Clean Up

For objects using native resources, a destroy( ) method must be called once the object is not used any more. This method may not be strictly necessary as Java garbage collector will reclaim memory once the object and its references are out of scope. However, in practice, the garbage collector may be too slow for native resources (and in particular hardware resources) to be cleaned up before a new content requires the same hardware resources. In such situations, the resources might not be available and the application manager may think there is a hardware error (hence killing the application), while in fact waiting for the garbage collector to kick in would release hardware resources and allow the application to run. Unfortunately, there is no way to predict if this is an error or a matter of time; the easiest way is to simulate what is done in other programming languages i.e. explicit clean up.

Since all heavy components use native resources—decoders, encoders, renderers, and so on—destroy( ) must be called.

It is important to note that explicit clean up may create a race condition: the application may call destroy( ) while the garbage collector cleans up the object and calls destroy( ) too. Therefore, it is advised to use proper thread synchronization mechanisms (e.g. locks).

1.5.2 MDGlet Architecture

The MDGlet interface has the following methods:
void init(MDGletContext context)—called when the MDGlet is loaded the first time. The context is provided by the application manager.
voidpause( ), stop( ), start( ), destroy( )—called by the application manager to notify the MDGlet about state changes. See subclause 1.5.2.1 for a description of MDGlet states.

The MDGletContext provides access to terminal resources and application state management and has the following methods:
Object getDisplay( )—returns javax.microedition.lcdui.Display for MIDP and java.awt.Frame for other Java profiles. This enables the application to add its own graphics components into the area provided by the terminals. These components can be Java components (e.g. Canvas, Graphics, Image) or Renderers using Java components as defined in this specification. DisplayNotAvailableException may be thrown if a display can not be granted at this time.
String getProperty(String key)—returns the value of a property within the terminal or from the application descriptor of the application (see section 1.5.11). null is returned if the key doesn't exist. For renderers, if a named renderer exists, this method returns the version of the renderer.
int checkPermission(String permission)—gets the status of the specified permission. If no API on the device defines the specific permission requested then it must be reported as denied. If the status of the permission is not known because it might require a user interaction then it should be reported as unknown. It returns 0 if the permission is denied; 1 if the permission is allowed; −1 if the status is unknown
ResourceManager getResourceManager( )—returns a ResourceManager to access resources.
void requestResume( )—requests the terminal to resume the application (see section 1.5.2.2).
void requestPause( )—requests the terminal to pause the application (see section 1.5.2.2).
   1.5.2.1 MDGlet States

An MPEGlet has five states:
Loaded: The MDGlet is loaded from local storage or network and its no argument constructor is called. It can enter the Initialized state if the MDGlet.init( ) method is called.
Initialized: The MDGlet is initialized and ready to be active. It can enter the Running state after the MDGletstart( ) is called.
Running: The MDGlet is running normally. It can enter the Destroyed state if MDGlet.destroy( ) method is called. It may also return to the Paused state if MDGlet.pause( ) method is called. It may enter the Initialized state if MDGlet.stop( ) is called.
Paused: The MDGlet is paused. It can enter the Running state after the MDGlet.start( ) is called. It can enter the Initialized state if MDGletstop( ) is called. When entering Paused state, applications are expected to release all shared resources and to save the data necessary to resume later in a state identical to that when pause was entered.
Destroyed: This is the terminal state. Once it's entered, it cannot return to other states. All its resources are subject to be claimed.

In addition, for example should an error occurs, the terminal may move the application into the Destroyed state from whatever state the application is already in.

1.5.2.2 MDGlet Requests to the Terminal

The previous section is used by the terminal to communicate to an MDGlet application that it wants the MDGlet to change state. If an MDGlet wants to change its own state, it can use the MDGletContext request methods.
The MDGlet calls its MDGletContext.requestPause( ) or
MDGletContext.requestResume( ) methods, which in turn notify the terminal. In return, the terminal calls MDGlet.pause( ) or MDGletstart( ) respectively.
   1.5.3 Native Memory Wrapper: NBuffer

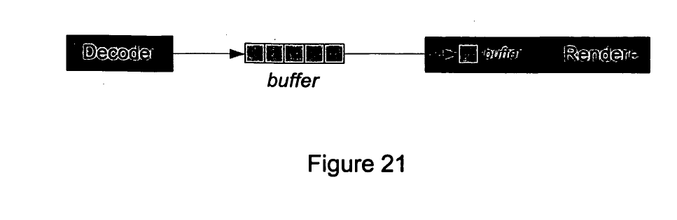

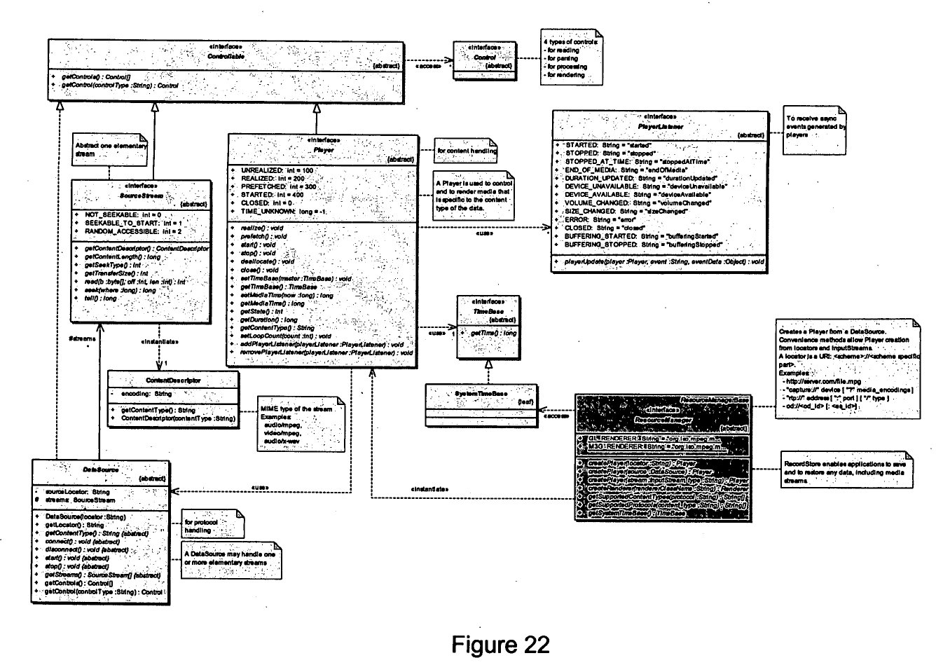

With low-level rendering methods, it is necessary to use and to share buffers for sending large amount of data to the graphic card such as image and geometry data. While using parts of a buffer is a basic feature in all native languages (e.g. C, C++), it is not always available in scripting languages such as Java. For security reasons, directly accessing memory of the terminal is dangerous as a malicious script could potentially access vital information within the terminal, thereby crashing it or stealing user information. In order to avoid such scenarios, we wrap native memory area into an object called NBuffer. FIG. 2 shows how an NBuffer is used in the case of the bindings to OpenGL and FIG. 21 shows how NBuffers are used between decoders and renderers within the context of the media API. An NBuffer is responsible for allocating native memory areas necessary for the application, putting information into it, and getting information from it. In Java Virtual Machine (JVM) 1.4 and higher, the ByteBuffer feature enables this feature. However, embedded systems use lower version of JVMs and hence don't have ByteBuffers. Moreover, ByteBuffers are a generic mechanism wrapping native memory area, providing a feature referred as memory pinning. With memory pinning, the location of the buffer is guaranteed not to move as the garbage collector reclaims memory from destroyed objects.

A NBuffer is a wrapper around a native array of bytes. No access to the native values is given in order to avoid native interface performance or memory hit for a backing array on the Java side; the application may maintain a backing array for its needs. Therefore, operations are provided to set values (setValues( )) from Java side to the native array. setValues( ) with source values from a NBuffer enables native memory transfer from a source native array to a native destination array.

1.5.4 Media API

The Media API is based on JSR-135 Mobile Multimedia API. This generic API enables playback of any audio-visual resource referred by its unique Uniform Resource Identifier (URI). The API is so high-level that it all depends on the implementers to provide enough multiplexers, demultiplexers, encoders, decoders, and renderers to render an audio-visual presentation. All of these services are provided as bundles as explained in section 1.5.1.

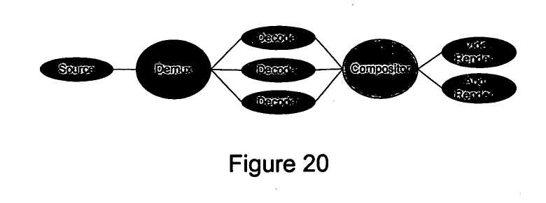

The Media API is the tip of the Media Streaming framework iceberg. Under this surface is the native implementation of Media Streaming framework. This framework enables proper synchronization between media streams and correct timing of packets from DataSources to Renderers or DataSinks. Many of the decoding, encoding, and rendering operations are typically done using specialized hardware. FIG. 20 shows how the various components are organized to play an audio-visual content. For example, let's take a DVD:
Source is the files on the disk
Demux is the MPEG-2 Transport Stream demultiplexer
Decoders are for video, audio, images, and subtitles
Compositor takes the output of visual decoders (video, images) and subtitles and compose them so that subtitles appear on top of the video
Renderers are for video (TV screen) and audio (speakers)
Not represented is the remote the user uses to interact with the DVD Player to control the playback preferences

For a general multi-media content, multiple sources may be used and many formats may be used to represent some information. Compositors may be generic for a set of applications or dedicated (optimized) for a specific purpose and likewise for renderers

Passive objects such as buffers (see section 1.5.2 on NBuffer) are used to control interactions between active objects. Such buffers may be in CPU memory (RAM) or in dedicated cards (graphic cards memory also called texture memory) as depicted in FIG. 21.

Since MDGlet applications can create their own renderer and control rendering thread, they must register with visual decoders so that the image buffer of a still image or a video can get stored on a graphic card buffer for later mapping.

1.5.4.1 Architecture

Compared to JSR-135, the Media API does not allow applications to use javax.microedition.media.Manager but requires usage of ResourceManager instead. ResourceManager and Manager have the same methods but ResourceManager is not a static class as Manager is, it enables creation of resources based on the application's context. This enables a simpler management of resource per applications' namespaces. Depending on the implementation, ResourceManager may call javax.microedition.media.Manager. But having Manager available to applications is not recommended as contextual information between many applications is not available to the terminal or it requires a more complex terminal implementation.

1.5.4.2 Players and Controls

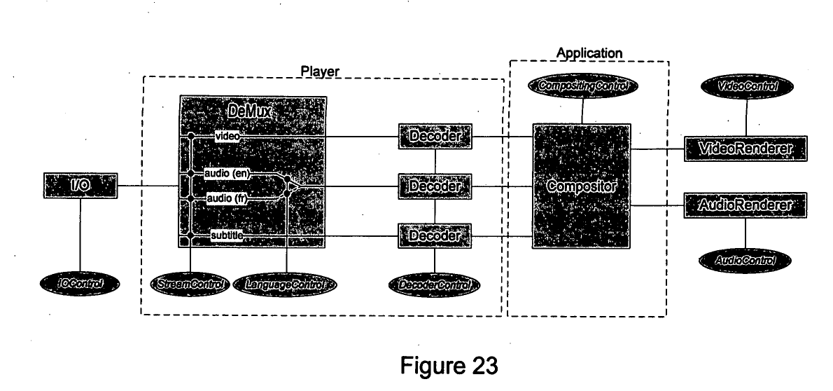

A Player plays a set of streams synchronously. A content may be a collection of such sets of streams. FIG. 23 depicts a content with a video, 2 audio streams (one French and one English language), and a subtitle stream. Each stream may expose various controls. For example, the user may control if the subtitle stream is on or off, if audio should be in French or English, if playback should be stopped, paused, rewinded etc., if audio output should use an equalizer, if video output needs contrast adjustments, and so on.

When there are multiple audio or visual streams, a compositor is used and CompositingControls may be defined. However, one of the particularities of this invention is that the Compositor is programmatically defined: it is the application. Early systems had internal compositors that would compose visual streams in a particular order. For example, DVD and MHP-based systems compose video layers one on top of the other: the base layer is the main video, followed by subtitle, then 2D graphics, and so on. The essence of the invention is precisely to avoid such rigid composition and hence CompositingControls may never be needed in general. CompositingControls are needed if and only if the framework is used to build a system compliant with such rigid composition specifications (especially MHP-based systems).

There are 4 types of controls among others:
IO controls—these controls act on the protocols used to fetch content
Processing controls—these controls act on the processing of the content and of its individual streams
   Multiplexers/demultiplexers—act on multiplexed formats
   Decoders/Encoders/Transformers—act on single stream coding or transformation
Rendering controls—act on the presentation of the decoded output of decoders or of compositor (e.g. compositing and rendering instructions)
DRM controls—Digital Rights Management is orthogonal to the processing of media and often act as a barrier to the media flow.

It should be clear that these are just examples of Controls useful for the invention described in this document and more can be added at any time, even at runtime:
Other types of controls may be available such as MetadataControl, which exposes <key, value> pairs and may be used to characterize various information (e.g. title of the content, description, author, and so on). Some of these metadata may be part of standards such as ID3 tags for music.
For vertical applications, vendors may define their own controls, thereby extending the framework for specific applications without the need to modify the framework specification. Of course, applications must know about the controls and vendors can simply document their components.
   1.5.4.3 Multimedia Controls

The media API is a high-level API. One of the core features is to be able to launch a player to play a content and, for each stream in this content, the player may expose various controls that may affect the output of the player for a particular stream or for the compositing of multiple streams.

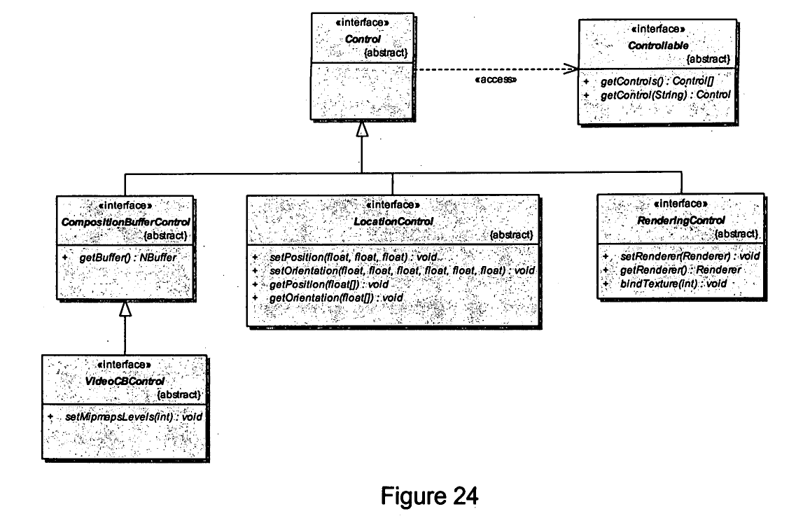

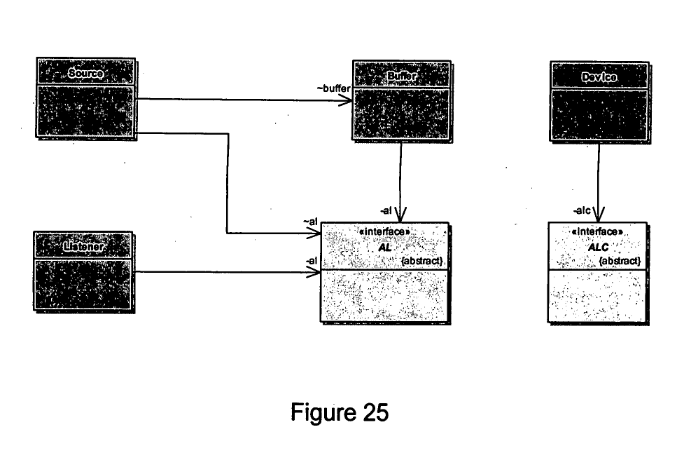

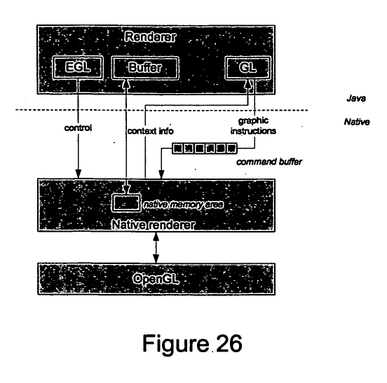

FIG. 24 describe special controls used in our framework:
RenderingControl—this control enables the video output of a player to be attached to a Renderer created by the application.
LocationControl—allows the application to provide the position and orientation of the user in a 3D world (for spatialization effects)
   1.5.4.4 Advanced Audio API

The advanced audio API is built upon OpenAL (see, for example, Creative Labs. OpenAL. http://www.openal.org, supra) and enables 3D audio positioning from monoral audio sources. The goal is to be able to attached audio sources to any objects and depending on its location relative to the user, its speed of movement, and atmospheric and material conditions, the sound will evolve in a three dimensional environment.

Similar to the Java bindings to OpenGL, we define Java bindings to OpenAL via an Audio API in accordance with the resources of the embedded device that wraps the equivalent OpenAL structures. Those skilled in the art will be able to produce a suitable Advanced Audio API in view of this description. An exemplary API is listed in Annex C.

On top of OpenAL, we define a Java API with the following features:
Source—defines an audio source. There can be many audio sources, each with the following parameters:
   Position—a 3D position of the audio source
   Direction—a 3D unit vector
   Cone—the cone of sound for directional sources
   Velocity—a 3D vector in units/second
   Gain and its bounds
   Damping factors
   Pitch
   Looping
   Source relative to the listener or absolute
Listener—defines parameters of the listener. There is only one listener per scene with the following parameters:
   Position—3D position of the listener
   Orientation—contains up and look-at 3D vectors
   Velocity—3D vector
   Gain
Buffer—holds decoded audio data (or PCM data). It extends NBuffer with audio-specific information
   Bit depth
   Frequency in Hz
   Number of channels (e.g. 1 for mono, 2 for stereo)
   Audio data (PCM data)
Device—encapsulates the device (i.e. audio hardware) context

Audio source position and direction, listener position and orientation, are directly known from the geometry of the scene. This enables usage of a unique scene graph for both geometry and audio rendering. However, it is often simpler to use two separate scene representations: one for geometry and one for audio; clearly audio can use a much more simplified scene representation.

1.5.5 Timing and Synchronization

The proposed terminal architecture maintains all media in sync. The timing model for a media is:
tₛ=tₛₜₐᵣₜ+rate.(t^{ref}−tₛₜₐᵣₜ^{ref})
where
tₛ is the stream time in milliseconds
tₛₜₐᵣₜ is the starting position in the stream
rate is the playback rate. 1 for normal playback, 2 for double speed, 0.5 for half speed. Negative playback provide playback backward in time.
t^{ref} is the reference time i.e. the absolute time returned by the clock
tₛₜₐᵣₜ^{ref} is the reference start time when the media decoder was last started.

Therefore, when the decoder is stopped, tₛ remains constant. When it is stopped, tₛ is undefined, and when seeking a new position and restarted, tₛ=tₛₜₐᵣₜ.

t_{ref} is not important as long as it is monotically increasing. It is typically given from the terminal's system clock but may also come from the network.

1.5.6 Network API

From an MDGlet application point of view, any network protocol can be used: it suffices to use the URI with the corresponding <scheme>. OSGi and Java profiles provide support for HTTP/HTTPS and UDP.

Our framework is extended to support other protocols: RTP/RTSP, DVD, TV (MPEG-2 TS). Each protocol is handled by a separate bundle. Hence the framework can be updated at any time as new protocols are needed by and are available to applications.

1.5.7 Java Bindings to OpenGL (ES)

Since OpenGL ES is a subset of OpenGL and EGL is a sufficient and standard API for window management, Mindego uses the same design for OpenGL, OpenGL ES, OpenVG, and other renderers. This enables to have a consistent implementation of renderers and often a fast way to integrate a renderer into our platform geared at resource-limited devices.

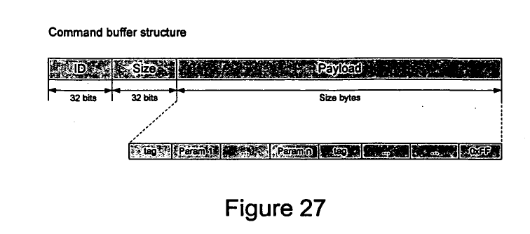

The OpenGL renderer is designed like other components (FIG. 2): a lightweight Java part and a heavier native part. However, unlike other components, the renderer is called by the application's thread at interactive rate (e.g. 30 times per second). For this reason, crossing the Java-Native barrier would be too costly and we prefer buffering the commands into a command buffer (FIG. 27).

The structure of the command buffer consists of a list of commands represented by a unique 32-bit tag and a list of parameter values typically aligned to 32-bit boundary. When the native renderer processes the command buffer, it dispatches the commands by calling the native method corresponding to the tag, which retrieves its parameters from the command buffer. The end of the buffer is signaled by the special return tag 0xFF.

Some commands may return value to the application. For these, we use the same mechanism with a context info buffer that the Java renderer can process to get the returned value.

The size of the command buffer is bounded and it takes some experimentation for each OS to find the size for the best overall performance. Not only a buffer is always bounded on a computer but it is also important to flush the buffer periodically when many commands are sent so to avoid waiting between buffering the command and their processing/rendering on the screen.

Whenever possible, native buffers are used to accelerate memory transfers to OpenGL graphic card; this is especially true for:
Vertex buffers—meshes are large collections of vertices and their attributes. They must be stored in large area of memory
Textures—textures use large areas of memory and must be transferred quickly to the card for various effects. Dynamic textures (e.g. video) are asynchronously updated and sent directly to the graphic card's texture memory (without passing through Java). Image manipulation algorithms also perform faster on native memory rather than Java's.
   1.5.7.1 API Design

In order to facilitate the conversion of native OpenGL applications to this binding, we define a Renderer object that exposes two interfaces:
EGL—exposes all EGL Window system methods and constants
GL—exposes all OpenGL ES methods and constants

The naming of native to Java methods is straightforward; it is a one to one mapping with the following rules in Table 1.

TABLE 1
C to Java type conversion rules.

| | Java type |
|---|---|
| C type | public final const int GL_constant = |
| #define GL_constant 0x1234 | 0x1234 |
| const | |
| GLAPI | |
| APIENTRY | int |
| GLenum | boolean |
| GLboolean | int |
| GLbitfield | byte |
| GLbyte | short |
| GLshort | int |
| GLint | int |
| GLsizei | byte |
| GLubyte | short |
| GLushort | int |
| GLuint | float |
| GLfloat | float |
| GLclampf | void |
| GLvoid | int |
| GLfixed | int |
| GLclampx | |
| EGLBoolean; | boolean |
| EGLint; | int |
| void *EGLDisplay; | EGLDisplay |
| void *EGLConfig; | EGLConfig |
| void *EGLSurface; | EGLSurface |
| void *EGLContext; | EGLContext |
| glXXX<type>v( . . . , GL<type> | glXXXv( . . . , <type>[ ] params) |
| *params) | |
| void *pointer | NBuffer pointer |
| &pointer[offset] | NBuffer pointer, int offset |
| glGetIntegerv(GLenum pname, | glGetIntegerv(int pname, int[ ] params) |
| GLint *params) | * see note below about state |
| | query methods |
| GLAPI const GLubyte * | String glGetString (int name); |
| APIENTRY glGetString | |
| (GLenum name); | |
| GLAPI void APIENTRY | void glGenTextures (int n, [ ] |
| glGenTextures (GLsizei n, | textures); |
| GLuint *textures); | |
| GLAPI void APIENTRY | void glDeleteTextures (int n, int[ ] |
| glDeleteTextures (GLsizei n, | textures); |
| const GLuint *textures); | |
| Texture methods | * see note below |
| Vertex array methods | * see note below |

The last two rules add a change for all methods that use memory access. As discussed in section 1.5.2, memory access is provided by NBuffer objects that wrap native memory. NBuffer could provide an offset attribute to mimic the C call but we believe it is clearer to add an extra offset parameter to all GL methods using arrays of memory (or pointers to it). Therefore the following methods have been modified:

Texture methods
GLAPI void APIENTRY glCompressedTexImage2D (GLenum target,
GLint level, GLenum internalformat, GLsizei width, GLsizei height,
GLint border, GLsizei imageSize, const GLvoid *data);
GLAPI void APIENTRY glCompressedTexSubImage2D (GLenum target,
GLint level, GLint xoffset, GLint yoffset, GLsizei width,
GLsizei height, GLenum format, GLsizei imageSize, const GLvoid *data);
GLAPI void APIENTRY glReadPixels (GLint x, GLint y, GLsizei width,
GLsizei height, GLenum format, GLenum type, GLvoid *pixels);
GLAPI void APIENTRY glTexImage2D (GLenum target, GLint level,
GLint internalformat, GLsizei width, GLsizei height, GLint border,
GLenum format, GLenum type, const GLvoid *pixels);
GLAPI void APIENTRY glTexSubImage2D (GLenum target, GLint level,
GLint xoffset, GLint yoffset, GLsizei width, GLsizei height, GLenum
format, GLenum type, const GLvoid *pixels);
Vertex array methods
GLAPI void APIENTRY glColorPointer (GLint size, GLenum type,
GLsizei stride, const GLvoid *pointer);
GLAPI void APIENTRY glDrawElements (GLenum mode, GLsizei count,
GLenum type, const GLvoid *indices);
GLAPI void APIENTRY glNormalPointer (GLenum type, GLsizei stride,
const GLvoid *pointer);
GLAPI void APIENTRY glTexCoordPointer (GLint size, GLenum type,
GLsizei stride, const GLvoid *pointer);
GLAPI void APIENTRY glVertexPointer (GLint size, GLenum type,
GLsizei stride, const GLvoid *pointer);

Texture methods
int width, int height, int border, int imageSize, NBuffer data, int
offset);
void glCompressedTexSubImage2D (int target, int level, int xoffset, int
yoffset, int width, int height, int format, int imageSize, NBuffer
data, int offset);
void glReadPixels (int x, int y, int width, int height, int format, int
type, NBuffer pixels, int offset);
void glTexImage2D (int target, int level, int internalformat, int
width, int height, int border, int format, int type, NBuffer pixels,
int offset);
void glTexSubImage2D (int target, int level, int xoffset, int yoffset,
int width, int height, int format, int type, NBuffer pixels, int
offset);
Vertex array methods
void glColorPointer (int size, int type, int stride, NBuffer pointer,
int offset);
void glCompressedTexImage2D (int target, int level, int internalformat,
void glDrawElements (int mode, int count, int type, NBuffer indices,
int offset);
void glNormalPointer (int type, int stride, NBuffer pointer, int
offset);
void glTexCoordPointer (int size, int type, int stride, NBuffer
pointer, int offset);
void glVertexPointer (int size, int type, int stride, NBuffer pointer,
int offset);

State query methods such as giGetIntegerv( ) are identical to their C specification and the application developer must be careful to allocate the necessary memory for the value queried.

For all methods, if arguments are incorrect or an error occurs in Java or in native side, a GLException is thrown. Those skilled in the art will be able to produce a suitable OpenGL API in view of this description. An exemplary OpenGL ES API is listed in Annex A.

1.5.7.2 GL Versioning

Since its inception OpenGL went through several versions, from 1.0 to 1.5 and today 2.0 is almost ready. Recently, the embedded system version, OpenGL ES, appeared as a lightweight version of OpenGL: OpenGL ES 1.0 is based on OpenGL 1.3 and OpenGL ES 1.1 on OpenGL 1.5. Likewise, OpenGL ES 2.0 is based on OpenGL 2.0.

With OpenGL ES, a native window library, EGL, has been defined. This library establishes a common protocol to create GL window resources among OS; this feature is not available on desktop computers but EGL interface can be implemented using desktops' OS windowing libraries.

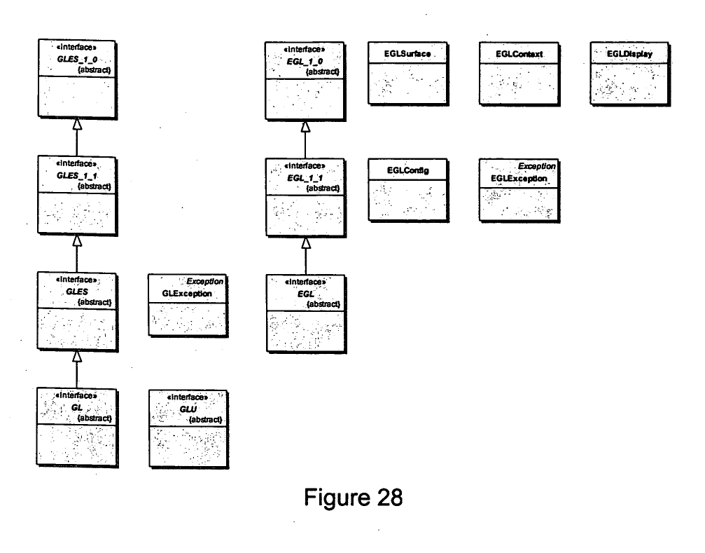

Therefore, we implement OpenGL binding starting with attributes and methods of OpenGL ES 1.0, extend it for OpenGL ES 1.1, and ultimately extend it to OpenGL and GLU (the OpenGL Utility library). The same holds for EGL. FIG. 28 depicts this organization.

It should be noted that OpenGL and OpenGL ES provide vendor extensions. While we have included all extensions defined by the standard in GLES and GL interfaces, if the graphic card doesn't support these extensions, the methods don't have any effect (i.e. nothing happens). Another way would be to organize the interfaces so that each vendor extension has its own interface which would be exposed if and only if the vendor extension is supported. Whatever way is an implementation issue and doesn't change the behavior of the API.

1.5.7.3 EGL Design

OpenGL ES interface to a native window system defines four objects abstracting native display resources:
EGLDisplay, represents the abstract display on which graphics are drawn
EGLConfig describes the depth of the color buffer components and the types, quantities and sizes of the ancillary buffers (i.e., the depth, multisample, and stencil buffers).
EGLSurface are created with respect to an EGLConfig. They can be a window, a pbuffer (offscreen drawing surface), or a pixmap.
EGLContext defines both client state and server state.

We define exactly the same objects in Java, they wrap information used in the native layer. A user never has access to such information for security reasons, as explained in previous sections of this document.

EGL methods are controls methods (see FIG. 2). There is no need for a command buffer as they are executed very rarely (e.g. typically at the beginning and end of an application) and hence have little or no impact on the rendering performance of the terminal.

The naming conventions are the same as for GL (see Table 1).

1.5.7.4 Performance Issues

The disclosed API is designed to reduce the time needed to access the native layer from a scripting language (such as Java) layer. It is also designed to reduce or to avoid bad commands to crash the terminal by simply checking commands in the Renderer before they are sent in the graphic cards (note that these checks can be done in Java and/or in the native code).

It is important to note that from the Java side, an application sees OpenGL calls but has no direct access to the graphic context and therefore the native Renderer can be OpenGL (see, for example, Khronos Group, OpenGL ES 1.1. http://www.khronos.org, supra) (see, for example, Silicon Graphics Inc. OpenGL 1.5. Oct. 30, 2003, supra) or any other graphic software, software or hardware such as DirectX (see, for example, Khronos Group, Open VG. http://www.khronos.org, supra). Likewise, the server that renders the image need not reside on the same terminal.

Querying the rendering context is expensive because it requires crossing the JNI from the native layer to the Java layer, which typically costs more than the other way. Fortunately, querying the rendering context is rarely done so the overall performance hit on the application is minimal. Such state data are of few types: an integer, a float, a string, an array of integers, or an array of floats. Therefore, these objects can be created in the Java part of the renderer and filled from the native side of the renderer, whenever a state query method is called. By doing so, the Java state variables can be cached in the native side and the overhead of crossing the Java Native Interface is minimal.

In our design, we don't cache the rendering context in order to avoid costly memory usage. However, on the native side, whenever there is an error, the error state—which is part of the state data described above—on the Java side is updated. Further rendering commands won't call the native side until the error is cleared, which avoids further errors to be propagated and potentially a crash of the terminal.

1.5.7.5 GL Extensions

EGL defines a method to query for GL extensions. When an extension is available a pointer to the method is returned. Since pointers are not exposed in Java, we choose to define to add GL or EGL methods defined in future versions of the specification in GL and EGL interfaces respectively.

With our design, if an application access such an extension but the method is not available in the native GL driver, a MethodNotAvailable exception is thrown. Note that one might also choose not to throw an exception and silently ignore the request; no information is passed to the native layer so there is no risk of crashing the terminal.

1.5.7.6 Binding to a Canvas

As any other language with drawing features, Java defines a Canvas for a Java application to draw on. In order to create the rendering context, the native renderer must access the native resources of Java Canvas. It is also necessary to access these resources before configuring the rendering context, especially with hardware accelerated GL drivers. In Java 1.3+, JAWT enables access to the native Canvas. For MIDP virtual machines, Canvas is replaced by Display class.

In order to avoid multithreading issues between rendering context and Java widget toolkit (or AWT), the Canvas should not be used for rendering anything else than OpenGL calls and it is a good practice to disable paint events to avoid such conflicts. In fact, to mix 2D and 3D graphics is best to use OpenVG (see, for example, Khronos Group, Open VG. http://www.khronos.org, supra) and OpenGL (see, for example, Khronos Group, OpenGL ES 1.1. http://www.khronos.org, supra) calls rather than mixing AWT calls on the Canvas (even if this is possible, it is slow).

1.5.7.7 Sequence of Operations

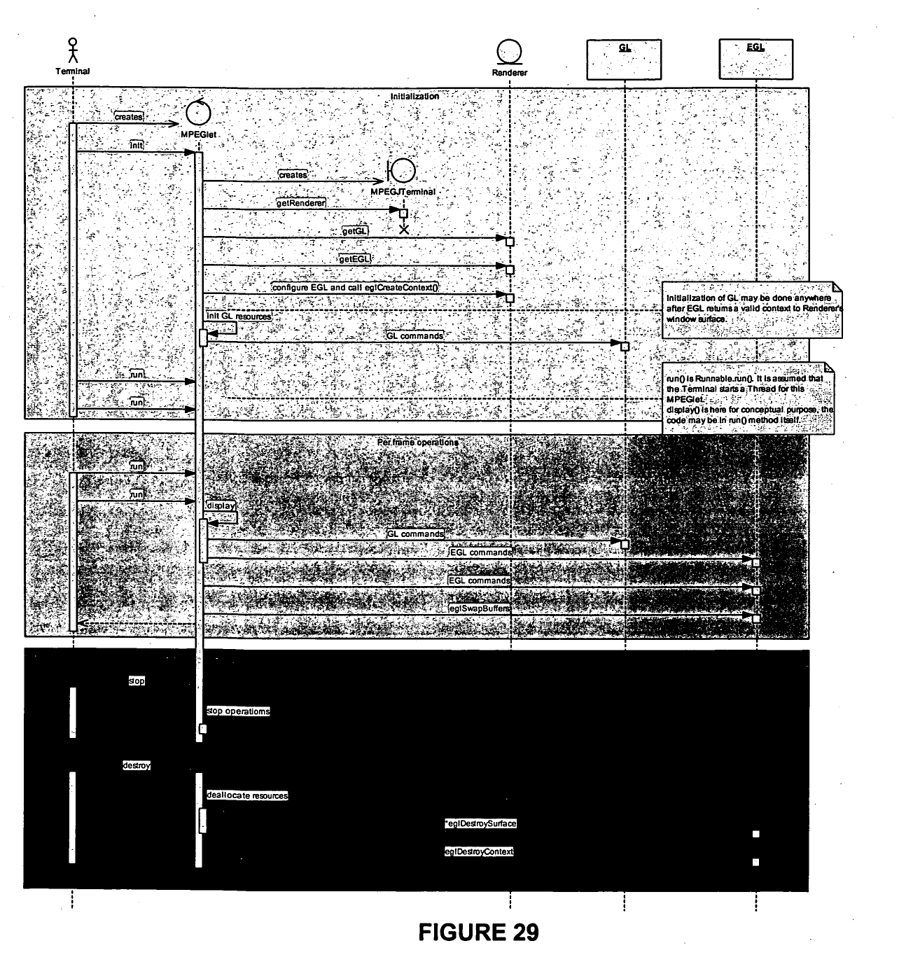

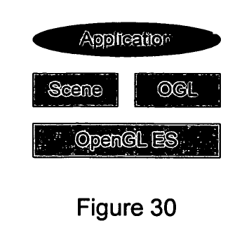

Accessing low-level rendering resources is important in order to control many visual effects precisely. FIG. 29 shows the typical lifecycle of an MPEGlet (see, for example, ISO/IEC 14496-21, Coding of audio-visual objects, Part 21: MPEG-J Graphical Framework eXtension (GFX)) with respect to managing rendering resources. MPEGlets implement the same behaviour as MDGlets with respect to managing rendering resources.

Initialization

Once the terminal has created the MPEGlet, MPEGlet.init( ) method is called. The MPEGlet retrieves the MPEGJTerminal, which gives access to the Renderer. The MPEGlet can now retrieve GL and EGL interfaces.

From EGL interfaces, the MPEGlet can configure the display and window surface used by the Terminal. However, it would be dangerous to allow an application to create its own window and kills terminal's window. For this reason, eglDisplay( ) and eglCreateWindowSurface( ) don't create anything but returns the display and window surface used by the terminal. The MPEGlet can query the EGL for the rendering context configurations the terminal supports and create its rendering context.

Once the rendering context is successfully created (i.e. a non-null object), the MPEGlet can start rendering onto the rendering context and issue GL or EGL commands.

Per Frame Operations

GL commands are sent to the graphic card in the same thread used to create the renderer. According to OpenGL specification (see, for example, Silicon Graphics Inc. OpenGL 1.5. Oct. 30, 2003, supra) (see, for example, Khronos Group, OpenGL ES 1.1. http://www.khronos.org, supra), one thread at a time should use the rendering context i.e. EGLContext. Application developers should be careful when using multiple rendering threads so that rendering commands are properly executed on the right contexts and surfaces.

GL commands draw in the current surface, which can be a pixmap, a window, or a pbuffer surface. In the case of a window surface, a double buffer is used and it is necessary to call eglSwapBuffers( ) so that the back buffer is swapped with the front buffer and hence what was drawn on the back buffer appears on the terminal's display.

Destruction

When the application is stopped, MPEGlet.stop( ) is called and the MPEGlet should stop rendering operations. When the application is destroyed, MPEGletdestroy( ) is called. The MPEGlet should deallocate all resources it created and call eglDestroySurface( ) for the surfaces it created and eglDestroyContext( ) to destroy the rendering context created at initialization time (i.e. in init( ) method).

1.5.8 Scene API

JSR-184 Mobile 3D Graphics (M3G) (see, for example, Java Community Process, Mobile 3D Graphics 1.1, Jun. 22, 2005. http://jcp.org/aboutJava/communityprocess/final/jsr184/index.html, supra) is a game API available on many mobile phones. This lightweight API provides an object-oriented model of OpenGL ES specification with advanced animation (gaming) features. However, M3G has some limitations:
many OpenGL ES features are not exposed
usage of Java buffers instead of fast native buffers (NBuffer in section 1.5.2)
animation framework is appealing but superfluous and other models could have been used i.e. it could have been a separate optional package
skinning, morphing and similar features are useful for games with avatars but not heavy features that could have been made optional i.e. put in a separate optional package
in order to issue calls to the native software/hardware, a Manager centralizes all calls and hence become a bottleneck when multiple applications are running on the same virtual machine. That may not make sense on mobile devices but this design may limit scalability on higher devices

We have defined an API that reuses the Core scene API of M3G and we have augmented it with full support for OpenGL ES 1.1 features since our implementation uses OpenGL ES 1.1 hardware and we allow dynamic creation of such renderers instead of using a static Manager. A less optimal implementation uses our implementation of Java bindings to OpenGL ES; in this case, instantiating such a renderer is like instantiating a pure OpenGL ES renderer.

The advantage of our design is that it enables mixing of OpenGL ES calls with this high-level API and hence enables developer to create pre- and post-rendering effects while using high-level scene graphs.

Those skilled in the art will be able to produce a suitable scene API in view of this description. An exemplary listing of an NBuffer API is provided in Annex B.

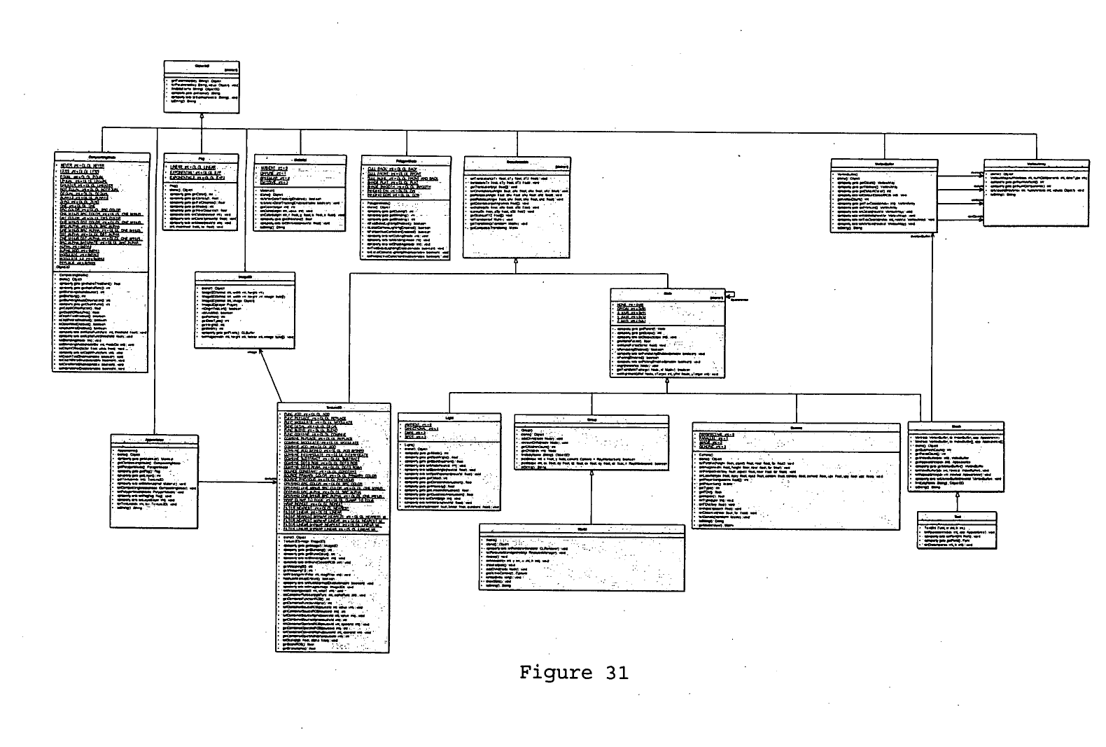

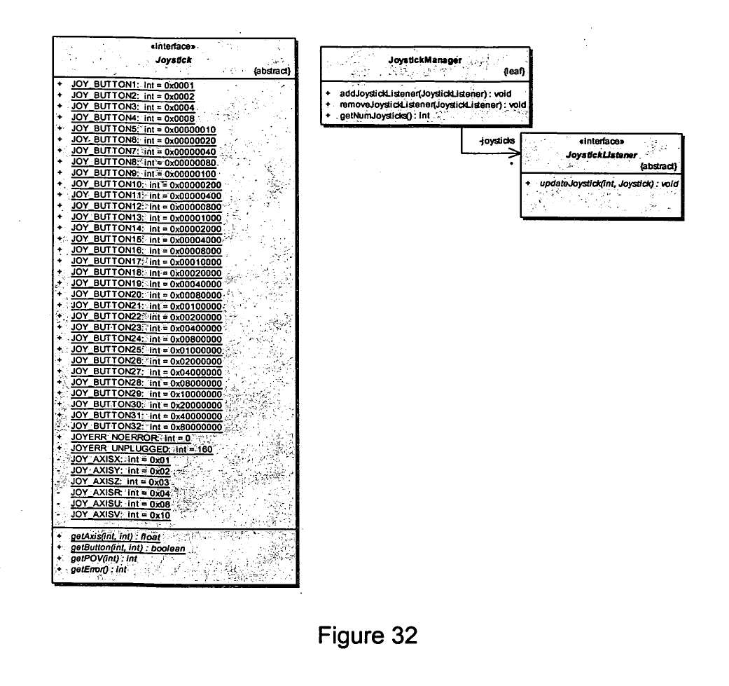

FIG. 31 depicts the class diagram of the scene API. Compared to M3G (see, for example, Java Community Process, Mobile 3D Graphics 1.1, Jun. 22, 2005. http://jcp.org/aboutJava/communityprocess/final/jsr184/index.html, supra), it has the following features:
Nodes have attributes and both can be named and searched through the tree of classes.
Each Node has only one parent. Therefore, the structure defined by the hierarchy of Node for a scene is like a tree rather than a graph.
Images can come from a native NBuffer (extensions to Image2D) via Media API's Players.
All OpenGL compositing modes are now available (extensions to CompositingMode)
All texture blending modes are now available (extensions to Texture2D)
There is text support (Text class)
World has a render( ) method so to ask the renderer to draw the scene.
There can be multiple Worlds
There is no central static Manager to perform rendering of Worlds and Nodes. Instead a Renderer must be created by the application and attached to the World. Likewise, the ResourceManager used by the application must be attached to the World for the resources it might need
World.destroy( ) must be called to destroy all resources used by a World.

The Scene API contains various optimizations to take advantage of the spatial coherency of a scene. Techniques such as view frustum culling, portals, rendering state sorting are extensively used to accelerate rendering of scenes. In this sense, the Scene API is called a retained mode API as it holds information. In comparison, OpenGL is an immediate mode API. These techniques are implemented in native so to take advantage of faster processing speed.

1.5.8.1 Data Types

M3G only supports integer types. Our API is extended to support all data types OpenGL ES supports: byte, int, short, float, wherever appropriate.

1.5.8.2 Meshes

The IndexBuffer class defines faces of a mesh. In M3G the class is abstract and TriangleStripArray extends it to define meshes made of triangle strips. We believe this definition to be too restrictive and instead define an IndexBuffer class that can support many types of faces: lines, points, triangles, triangle strips.

As for M3G, a mesh may be made of multiple sub-meshes. But unlike M3G, submeshes may be made of different types of faces.

1.5.8.3 Compositing, Texturing

M3G is incomplete in its support of compositing modes and texture blending. We have extended CompositingMode and Texture2D to support all modes GL ES supports. For images, we follow M3G definition of Image2D. However, we allow connection to a NBuffer of a Player for faster (native) manipulation of image data.

1.5.9 Persistent Storage Using Record Management Store

Persistent storage typically refers to the ability of saving state information of an application. If the persistent store is on a mobile device (e.g. USB key chain storage), this state information may be used in various players. An application may need to store: application-specific state information, updated applications if downloaded from the net and accompanying security certificates. The format in which state information is stored is application specific.

The Mobile Information Device Profile (MIDP) for J2ME defines a Record Management Store (RMS) (see, for example, Java Community Process, Mobile Information Device Profile 1.0/2.0, November 2002, http://www.jcp.org/en/jsr/detail?id=118), which is a record-oriented approach with multiple record stores. Using RMS is as follows:
Open a record store: RecordStore rs=RecordStore.openRecordStore(“MyStore”, true);
Close a record store: rs.closeRecordStore( );
Delete a record store: rs.deleteRecordStore(“MyStore”);
Add a record: rs.addRecord(bytes, 0, numBytes);
Get a record: rs.getRecord(recordId, buffer, offset);
Etc.

Since buffer is a byte array, the application can store whatever data in whatever format.

1.5.10 User Interaction Devices

Over the years, user interaction devices improved tremendously. Today's remotes have many buttons and with interactive contents, it is likely that remotes will evolve to include joysticks features. Likewise, it is conceivable that users could use other interaction devices than their remotes plugged to the DVD player or set-top boxes e.g. a Playstation or Xbox joystick, a wheel, a dancing pad, a data glove, etc.

All these devices have in common: many buttons, one or more analog controls, and point of views. In previous architectures, buttons are mapped to keyboard events and only one analog control is mapped to mouse events. This way, an application can be developed reusing traditional keyboard/mouse paradigm. Clearly, given the diversity of user interaction devices, this approach doesn't scale with today's game controllers.

Therefore, instead of trying to adapt APIs not designed for these requirements, we propose to separate concerns: API for mouse events if a mouse is used in the system, API for keyboard events if a keyboard is used, API for joysticks if joysticks are used. A remote may combine one or more of these APIs.

Keyboard and Mouse events are already specified in MIDP profiles. We add the following API for joysticks:
JoystickManager to manages all joysticks in the system and query the number of joysticks connected
Joystick to retrieve values of specific joystick
JoystickListener for the JoystickManager to update all listeners (e.g. MDGlets) registered.
The terminal must support the property joystick.maxSupported to indicate the maximum number of joysticks (or controllers) it can support.

To ensure interoperability, the mapping of these values to physical buttons should be specified by industry forums. For example, this is the case for PlaysStation and Xbox joysticks so that even if the joysticks may be built by different vendors with different form factors, applications behave identically when the same buttons are activated.

1.5.11 Terminal Properties

Applications (MDGlets) must be able to retrieve terminal specific properties so to be able to adapt their behavior to the hardware and APIs available. A typical scenario would be:
Terminal loads an MDGlet application
MDGlet queries the terminal for supported Renderers
MDGlet requests the server to send the code for the appropriate Renderers
MDGlet registers some services to the framework
MDGlet requests services from the framework and if not available it provides links to servers where the framework can download the missing services given appropriate user rights
   Terminal properties are retrieved by calling:
Object System.getProperty(property_name) for a Java Virtual Machine property
Object MDGletContextgetProperty(property_name) for a terminal property

where property_name is a String of the form: category.subcategory.name and the returned value is an Object. If the property is unknown a null value is returned.

TABLE 2
Example of terminal properties an application can query.

| Property | Return value | Example of value |
|---|---|---|
| cpu.speed | Integer | 3000 |
| cpu.type | String | Pentium |
| cpu.architecture | String | x86 |
| cpu.num | Integer | 1 |
| renderer.names | String[ ] | {com.mindego.renderer.opengl, |
| | | com.mindego.renderer.osg} |
| renderer.num | Integer | 2 |
| screen.dimension | int (see, for | {800, 600} |
| | example ISO/IEC, | |
| | 14496-1, | |
| | Coding of audio- | |
| | visual objects, | |
| | Part 1: Systems) | |

2 Applications & Authoring

As discussed in section 1.3, the proposed architecture provides these main features:
Existing applications can run on an extensible platform
Applications can be delivered in terms of components and use services in the framework
Multimedia contents consist of media assets and logic. This logic is programmatic. Both assets and logic can be protected and delivered separately
Multiple applications may run concurrently and in their own namespace

Today multimedia applications are authored and packaged as one unit, which is both inefficient in terms of production, delivery, and storage. Having applications made of separate components enable faster time to market, faster delivery, and independent ownership of components. Likewise, applications sharing components do not need to be repackaged once a component is updated: only the updated components need to be downloaded. Finally, using the object-oriented paradigm, applications can be authored in completely new way (see section 1.5.1.4) and this leads to a new generation of multimedia applications and developers.

For system administrators, device providers, and the like, it is also possible to remotely manage devices and update core system components, for example, hardware drivers in a secure manner thanks to Java security model and fine-grained security model available in the platform.

Last but not least, even though the logic of the application requires programming skills, one can imagine mainstream authoring tools where non-programmers can combine components visually to create applications, to customize, and to deploy applications. This is the exact analogy with what happened with the World-Wide Web: the HTML language was invented and reserved to programmers until more visual authoring tools appeared that allowed anybody to build its own web site.

2.1 Authoring Applications

Authoring a multimedia application typically requires the following steps:
1. authoring media assets (audio, video, images, and so on)
2. authoring application logic using a programming language
3. apply rights and encryption to assets and logic
4. multiplex and deploy

Steps 1 and 2 can go in parallel and so does step 3 which can happen at the end of steps 1 and 2. Step 3 is often dependent on the deployment scenario: specific types of Digital Rights Management (DRM) may be applied depending on the intended usage of the content.

In a peer-to-peer scenario, applications and components may be deployed on many sites so that when an application requests a component, it may be available faster than through a central server. Conversely, components being distributed require less infrastructure to manage at a central location.

File Listing Appendix

The following is a list of the files of the CD Computer Program Listing Appendix filed with this document:

| title | description |
|---|---|
| AnnexA | OpenGL ES API |
| AnnexB | Scene API |
| AnnexC | Advanced Audio API |

1. A multimedia terminal for operation in an embedded system, the multimedia terminal comprising:
a native operating system that provides an interface for the multimedia terminal to gain access to native resources of the embedded system;
an application platform manager that responds to execution requests for one or more multimedia applications that are to be executed by the embedded system;
a virtual machine interface comprising a byte code interpreter that services the application platform manager; and
an application framework that utilizes the virtual machine interface and provides management of class loading, of data object life cycle, and of application services and services registry, such that a bundled multimedia application received at the multimedia terminal in an archive file for execution includes a manifest of components needed for execution of the bundled multimedia application by native resources of the embedded system;
wherein the native operating system operates in an active mode when a multimedia application is being executed and otherwise operates in a standby mode, and wherein the application platform manager determines presentation components necessary for proper execution of the multimedia applications and requests the determined presentation components from the application framework, and wherein the application platform manager responds to the execution requests regardless of the operating mode of the native operating system.

2. A multimedia terminal as defined in claim 1, wherein the application platform manager responds to applications that include execution requests that specify terminal update operations such that the terminal update operations are performed regardless of the operating mode of the native operating system.

3. A multimedia terminal as defined in claim 1, wherein the application platform manager launches a player application that provides an interface through which a terminal user can specify media assets to be executed.

4. A multimedia terminal as defined in claim 1, wherein an application to be executed comprises application code, to be executed by the application platform manager, that is downloaded from a network server that communicates with the terminal.

5. A multimedia terminal as defined in claim 4, wherein the application code comprises an applet in a scripting language.

6. A multimedia terminal as defined in claim 1, wherein an application to be executed comprises application code, to be executed by the application platform manager, that is retrieved from local storage of the terminal.

7. A multimedia terminal as defined in claim 6, wherein the application code comprises an applet in a scripting language.

8. A multimedia terminal as defined in claim 1, wherein the application platform manager retrieves a saved state and reloads the saved state prior to executing any applications requested by a terminal user.

9. A multimedia terminal as defined in claim 1, further including a native memory buffer object of the application platform manger that provides a pointer to memory of the embedded system that is not managed by the application platform manager such that a plurality of native memory buffer objects of the application platform manager can share access to memory of the embedded system without exposure of the objects to the embedded system memory.

10. A multimedia terminal as defined in claim 9, wherein the native memory buffer object includes a method that sets values stored in the embedded system memory.

11. A multimedia terminal as defined in claim 1, wherein the application platform manager controls access to the services registry maintained by the application framework, controls permissions for a plurality of multimedia applications executing on the embedded system through the terminal, and supplies bindings for any multimedia application received that is not bundled so as to provide the application framework with a manifest of components needed for execution of the multimedia application.

12. A multimedia terminal as defined in claim 11, wherein the application platform manager restricts operation of each multimedia application such that each executes in its own namespace.

13. A multimedia terminal as defined in claim 11, wherein the bindings supplied by the application platform manager include bundles for data source parsing, data writing, data transforming, data encryption and rights management, security, and data rendering.

14. A multimedia terminal as defined in claim 11, wherein the application platform manager supplies bindings by maintaining state information of each multimedia application that is not bundled and provides sufficient information to the application framework to provide a manifest of components needed for execution of the multimedia application.

15. A method of operating a multimedia terminal of an embedded system, the embedded system including a native operating system that provides an interface for the multimedia terminal to gain access to native resources of the embedded system and a virtual machine interface comprising a byte code interpreter, the method comprising: responding to execution requests from one or more multimedia applications that are to be executed by the embedded system by determining presentation components necessary for proper execution of the multimedia application and requesting them from an application framework of the multimedia terminal that utilizes the virtual machine interface and provides management of class loading, of data object life cycle, and of application services and services registry, such that a bundled multimedia application received at the multimedia terminal in an archive file for execution includes a manifest of components needed for execution of the bundled multimedia application by native resources of the embedded system;
executing the multimedia application under control of an application platform manager that utilizes the presentation components as needed through the native operating system;
wherein the native operating system operates in an active mode when a multimedia application is being executed and otherwise operates in a standby mode, and wherein the application platform manager determines presentation components necessary for proper execution of the multimedia applications and requests the determined presentation components from the application framework, and wherein the platform manager responds to the execution requests regardless of the operating mode of the native operating system.

16. A method of operating a multimedia terminal of an embedded system as defined in claim 15, further comprising:
responding to applications that include execution requests that specify terminal update operations such that the terminal update operations are performed regardless of the operating mode of the native operating system.

17. A method of operating a multimedia terminal as defined in claim 15, wherein the application platform manager launches a player application that provides an interface through which a terminal user can specify media assets to be executed.

18. A method of operating a multimedia terminal as defined in claim 15, wherein an application to be executed comprises application code, to be executed by the application platform manager, that is downloaded from a network server that communicates with the terminal.

19. A method of operating a multimedia terminal as defined in claim 18, wherein the application code comprises an applet in a scripting language.

20. A method of operating a multimedia terminal as defined in claim 15, wherein an application to be executed comprises application code, to be executed by the application platform manager, that is retrieved from local storage of the terminal.

21. A method of operating a multimedia terminal as defined in claim 20, wherein the application code comprises an applet in a scripting language.

22. A method of operating a multimedia terminal as defined in claim 15, wherein the application platform manager retrieves a saved state and reloads the saved state prior to executing any applications requested by a terminal user.

23. A method of operating a multimedia terminal as defined in claim 15, further including:
producing a native memory buffer object that provides a pointer to memory of the embedded system that is not managed by the application platform manager such that a plurality of native memory buffer objects of the application platform manager can share access to memory of the embedded system without exposure of the embedded system memory to the native memory buffer objects.

24. A method of operating a multimedia terminal as defined in claim 23, wherein the native memory buffer object includes a method that sets values stored in the embedded system memory.

25. A method of operating a multimedia terminal as defined in claim 15, wherein the application platform manager controls access to the services registry maintained by the application framework, controls permissions for a plurality of multimedia applications executing on the embedded system through the terminal, and supplies bindings for any multimedia application received that is not bundled so as to provide the application framework with a manifest of components needed for execution of the multimedia application.

26. A method of operating a multimedia terminal as defined in claim 25, wherein the application platform manager restricts operation of each multimedia application such that each executes in its own namespace.

27. A method of operating a multimedia terminal as defined in claim 25, wherein the bindings supplied by the application platform manager include bundles for data source parsing, data writing, data transforming, and data rendering.

28. A method of operating a multimedia terminal as defined in claim 25, wherein the application platform manager supplies bindings by maintaining state information of each multimedia application that is not bundled and provides sufficient information to the application framework to provide a manifest of components needed for execution of the multimedia application.

29. A multimedia terminal as defined in claim 1, wherein the application platform manager uses scripting bindings to a native platform graphics interface of the embedded device to enable rendering independently of display interfaces of the native operating system.

30. A multimedia terminal as defined in claim 1, wherein the application platform manager interoperates with a renderer component that is extensible so as to support multiple drive revisions.

31. A multimedia terminal as defined in claim 1, further including a scene API that is a high-level object-oriented representation of a driver's rendering methods and adds methods found in scene graphs for fast rendering of large scenes.

32. A multimedia terminal as defined in claim 1, wherein the platform manager processes multimedia applications including low-level pre-rendering and post-rendering scene commands.

33. A multimedia terminal as defined in claim 1, further including a Joystick API that provides a direct mapping to user interaction of a device producing axial and discrete commands.
